(19) United States
(12) Patent Application Publication
(10) Pub. No.: US 2025/0379874 A1
(43) Pub. Date: Dec. 11, 2025

(54) TECHNIQUES TO MANAGE VIRTUAL CLOCKS FOR A TIME SENSITIVE NETWORK

(71) Applicant: Intel Corporation, Santa Clara, CA (US)

(72) Inventors: Vuk LESI, Cornelius, OR (US); Shabbir AHMED, Portland, OR (US); Christopher GUTIERREZ, Hillsboro, IN (US); Marcio Rogerio JULIATO, Portland, OR (US); Manoj SASTRY, Portland, OR (US)

(73) Assignee: Intel Corporation, Santa Clara, CA (US)

(21) Appl. No.: 18/739,847

(22) Filed: Jun. 11, 2024

(51) Int. Cl. H04L 9/40

(52) U.S. Cl. CPC H04L 63/1416

(57) ABSTRACT

Techniques include a method, apparatus, system and computer-readable medium to enhance security for time-synchronized networking. A method includes decoding a reference message comprising time information to synchronize a hardware clock of a time sensitive network (TSN) node with a network time for a TSN, the reference message associated with a reference synchronization interval, selecting a virtual clock from a set of virtual clocks for the TSN node, the virtual clock associated with a first synchronization interval that is different from the reference synchronization interval, and adjusting a time for the virtual clock based on the time information from the reference message to synchronize the virtual clock with the network time for the TSN. Other embodiments are described and claimed.

### BACKGROUND

Many computing systems (e.g., autonomous systems, industrial systems, etc.) require real-time safety critical features. This often necessitates that timekeeping performance within the system has higher levels of security relative to other aspects of the system. For example, factories employ synchronized robots to accomplish coordinated tasks, often in the presence of human beings. In another example, robots utilize coordination to perform surgeries on humans. As yet another example, self-driving vehicles require synchronization of networked sensing elements to build a precise perception of the environment around the vehicle, including other vehicles, objects, hazards, and persons. Tools relied on to achieve the necessary time performance, synchronization, and bounded latency communication for such time sensitive systems to perform as needed is often referred to as time-synchronized networking.

In general, time-synchronized networking or time-sensitive networking defines a set of standards (and amendments) with the aim to enable time synchronization and deterministic data delivery in converged networks where time-critical (TC) traffic coexists with other types of traffic. Thus, there is a need to provide security for time-synchronized network devices to mitigate the risks associated with disruption in time-synchronized network operation from attacks on the timing of the network.

### BRIEF DESCRIPTION OF THE SEVERAL VIEWS OF THE DRAWINGS

To easily identify the discussion of any particular element or act, the most significant digit or digits in a reference number refer to the figure number in which that clement is first introduced.

FIG. 1A illustrates an aspect of a time-synchronized network (TSN) in accordance with one embodiment.

FIG. 1B illustrates an aspect of a TSN for sensors in accordance with one embodiment.

FIG. 1C illustrates an aspect of a TSN for actuators in accordance with one embodiment.

FIG. 2A illustrates an aspect of a TSN in accordance with one embodiment.

FIG. 2B illustrates an aspect of a timing diagram in accordance with one embodiment.

FIG. 3A illustrates an aspect of a TSN in accordance with one embodiment.

FIG. 3B illustrates an aspect of a timing diagram in accordance with one embodiment.

FIG. 4 illustrates an aspect of an apparatus in accordance with one embodiment.

FIG. 5 illustrates an aspect of an apparatus in accordance with one embodiment.

FIG. 6 illustrates an aspect of a system in accordance with one embodiment.

FIG. 7 illustrates an aspect of a logic diagram in accordance with one embodiment.

FIG. 8 illustrates an aspect of a logic diagram in accordance with one embodiment.

FIG. 9A illustrates an aspect of a logic diagram in accordance with one embodiment.

FIG. 9B illustrates an aspect of a logic diagram in accordance with one embodiment.

FIG. 10 illustrates a logic flow in accordance with one embodiment.

FIG. 11A illustrates an aspect of a TSN node in accordance with one embodiment.

FIG. 11B illustrates an aspect of a TSN node in accordance with one embodiment.

FIG. 12 illustrates an aspect of a computer-readable medium in accordance with one embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

The present disclosure is generally directed to low-latency techniques to recover a network clock time for a network node after detection of a security attack on systems operating on strict time requirements, such as systems based on time sensitive networks or time-synchronized networks (TSNs). Cyberattacks against Time-Synchronized Networks (TSN), such as time-sensitive networks, can cause a number of consequences. Besides desynchronizing a time of follower nodes, switches, etc., an attacker can also impact scheduled traffic which is the underlying foundation for bounded latency. Scheduled traffic is defined in various Institute of Electrical and Electronics Engineers (IEEE) standards, such as IEEE 802.1Qbv, for example. It aims at achieving network determinism by defining a schedule where nodes are allowed to transmit information. By computing a schedule for all nodes of the network, it becomes possible to precisely define data streams from talker nodes to listener nodes. Each node must obey a precisely determined set of transmit windows so that the goal of bounded latency is achieved. Any time misalignment will subsequently impact the alignment of the scheduled windows (e.g., Qbv windows). This can be due to functional problems, such as theoretical traffic scheduling not performing as supposed to in practice, as well as due to cyberattacks. Thus, it is necessary to have techniques to comprehensively cover these issues. Even more importantly, from a cybersecurity standpoint, it is mandatory to have a mechanism to properly respond and recover timing for the TSN system.

As noted, TSN defines a set of standards (and amendments) with the aim to enable time synchronization and deterministic data delivery in converged networks where time sensitive traffic coexists with other types of traffic. Various standards have been developed to address time-synchronized or time-sensitive communications. By way of example and not limitation, some standards for enabling time-synchronized communications include those promulgated by the IEEE and/or the International Electrotechnical Commission (IEC). For example, IEEE 1588, IEEE 802.1AS, IEEE 802.1Qbv and IEC/IEEE 60802 provide systems and methods for synchronizing device clocks. In one example, IEEE 1588 defines a precision time protocol (PTP) for time synchronization across a network. In another example, IEEE 802.1AS defines a time-sensitive networking protocol referred to as a generic PTP (gPTP) for time synchronization across a network, where time sensitive devices (e.g., clock followers) synchronize to a leader clock (e.g., clock leader). In yet another example, IEEE 802.1Qbv defines time-sensitive networking for deterministic latency through traffic scheduling. In still another example, IEC/IEEE 60802 defines time-sensitive networking profiles for industrial automation. Other examples include a network time protocol (NTP) which is a networking protocol for clock synchronization between computer systems over packet-switched, variable-latency data networks, network time security (NTS) which is a secure version of NTP, and other time-synchronized network protocols. Embodiments are not limited to these examples.

Time synchronization in a TSN requires tight software-hardware interplay. A device (or node) in a TSN may implement a clock manager as a software component and a hardware clock as a hardware component. The clock manager adjusts timing for the hardware clock to ensure synchronization with a common network time for the TSN. In one embodiment, for example, a precision time protocol (PTP) hardware clock (PHC) is periodically adjusted by a PTP for Linux (PTP4L) software module to account for time offset between a clock leader and a clock follower in PTP-synchronized nodes. When a software component receives incorrect time information, such as a time offset bias within messages carrying time synchronization information, the software can misconfigure or mis-control hardware for the PHC, thereby leading to incorrect timekeeping. For instance, attackers located external to a TSN-capable platform along a network path can tamper with messages carrying time information to synchronize the hardware clock. Examples include malicious switches and/or relays tampering with time-related messages, or external attackers injecting messages into the network, which ends up impacting a time of the nodes downstream. Consequently, system and applications depending on TSN capabilities will consume incorrect time. Accordingly, early detection of a corrupted messages and/or software components for a TSN node is critical within a TSN.

One conventional solution to address this problem is to implement one or more Intrusion Detection Systems (IDSs) to monitor devices within a TSN to identify any abnormal behavior. An IDS implements software, firmware or hardware to support one or more specialized security functions, such as detecting malicious behavior caused by an attacker. The IDS may be implemented on a TSN node or separate from a TSN node. The IDS receives as input messages containing time information for synchronizing a clock of a TSN node with a network time for the TSN. The IDS analyzes the messages to detect anomalies, such as slight modifications to the time information to cause a TSN node to update an internal clock with a wrong network time. Incorrect time synchronization can cause disruptions in time sensitive applications executing on the TSN node, such as causing collisions between cooperative robotic arms or delaying braking in an autonomous vehicle. When the IDS detects abnormalities in messages carrying time information, the IDS generates an alert and takes action to isolate any affected TSN applications and/or TSN nodes from a compromised TSN node.

However, once a TSN node receives the alert it may have already consumed compromised messages carrying erroneous time information. Clock followers in a TSN have a clock manager (e.g., a clock servo or controller) driving a hardware clock towards a zero-offset to a clock leader. A clock follower performs time synchronization using a fixed-rate process that includes a repetitive sensing, controlling, and actuation cycle. The clock manager performs time offset sensing based on messages carrying time information, clock adjustment computations based on the time information, and clock adjustments based on the clock adjustment computations (e.g., phase or frequency adjustments) to the hardware clock. The fixed-rate process repeats once every synchronization cycle as defined by a reference synchronization interval, such as a time synchronization (TSYNC) value, which is set at a system level. Since the clock manager for a TSN node continuously repeats the fixed-rate process every TSYNC, even a state-of-the-art (SOTA) IDS is capable of detecting network attacks only after a TSN node has consumed one or more compromised samples. In such cases, the TSN node may have already updated its hardware clock with the erroneous time information and desynchronized from a network time for the TSN. Former solutions attempt to repair the maliciously-influenced notion of time after-the-fact, or simply implements security protocols to isolate and take off-line any desynchronized TSN nodes.

To solve these and other challenges in systems implementing time-synchronized networking operations, embodiments implement low-latency techniques for TSN nodes to recover a network time for a TSN even after the TSN is under a desynchronization attack. Embodiments implement a solution that provides a clean clock state not influenced by network attacks at the time of detection by TSN nodes, even after the TSN node consumes erroneous time information generated by the attack. Specifically, embodiments implement a solution that intrinsically enables the time-synchronized system to keep track of a “live” clock that will not be affected by network-based attacks at the moment when the IDS is able to make a decision, which is typically several samples after the attack has commenced. This is achieved by making use of a quantifiable tradeoff between time synchronization Quality-of-Control (QoC) and providing security guarantees. At the time the network attack is detected, a clock manager for a TSN node is able to turn to a clock control loop of slower bandwidth for a virtual clock that has not yet consumed the attacked time measurements. Upon detecting a network-based attack targeting a particular clock follower, such as inserting bias in the network time measurements used to compute time offset, the clock follower immediately stops updating a set of virtual clocks from malicious samples, and it accesses a clean clock state (e.g., through a timekeeping application program interface (API)) from a virtual clock that has not been infected. In this manner, the timekeeping API offers access to a clean clock state when anomalous conditions are met.

A SOTA IDS, with false positive (FP) and/or false negative (FN) rates, may detect network attacks only after several samples have been consumed leaving a contaminated clock state that is unusable by any subsequent recovery mechanism. On the other hand, a virtual clock manager on the clock follower can maintain multiple clock control loops, referred to as “synchronization loops,” at different rates. For instance, if a baseline reference synchronization interval is 125 milliseconds (ms), a set of redundant synchronization loops may be updated at multiples of the reference synchronization interval, such as every k, n, x, and y synchronization intervals (e.g., 250 ms, 500 ms, 750 ms, and 1000 ms). By providing such redundancy in the instances when the network time measurements are consumed, a TSN node can gain resilience to network-based attacks. Consequently, when an attack is detected, the virtual clock manager can directly read an unaffected virtual clock that has not been updated using malicious time measurements. By doing so, the virtual clock manager is able to trade a small amount of QoC to achieve security guarantees. For instance, if the IDS detects the attack after a TSN node has already consumed 5 samples, the virtual clock manager for the TSN node can then initiate a recovery mechanism and pre-load initial conditions (e.g., a current, unaffected time) by reading from a synchronization loop that is designed to update a virtual clock at a synchronization interval that is greater than 5 times a reference synchronization interval (Ts). For example, if Ts=125 ms, then the virtual clock manager selects a synchronization loop for a virtual clock that is greater than or equal to 625 ms (5×125 ms=625 ms). The performance penalty is minimal for at least two reasons. In the benign case, the application is still synchronized to the baseline clock control loop (e.g., the one updated most frequently).

In the attack case, the clock manager is able to choose the synchronization loop that is unaffected by the attacker and offers a notion of time that is minimally desynchronized compared to the baseline clock control loop. For example, timekeeping accuracy degrades by only approximately 1 nanosecond (ns) when the clock control loop is updated every 250 ms instead of 125 ms, justifying the tradeoff with security guarantees. The implementation can be based on the standard virtual clock implementation in Linux timekeeping systems (e.g., PTP4L—Precision Time Protocol for Linux). There are no fundamental limitations to the number of redundant clock control loops and the cost of running them is virtually insignificant.

As a result, embodiments may provide faster and more accurate time recovery from security events occurring in real-time within an apparatus, device or network associated with a TSN. Without the proposed approach, customers will not have the ability to effectively recover from attacks in scheduled traffic in TSNs. With this capability, it is possible to have a fine-grained and constant monitoring of the system so that any interference caused by an attack is immediately remediated to obtain a clean clock state. Embodiments enable security products to provide a much higher security level and quality of services than competitors not deploying such an approach. It may be appreciated that other technical advantages exist as well, as will become apparent in the figures, description and claims discussed herein.

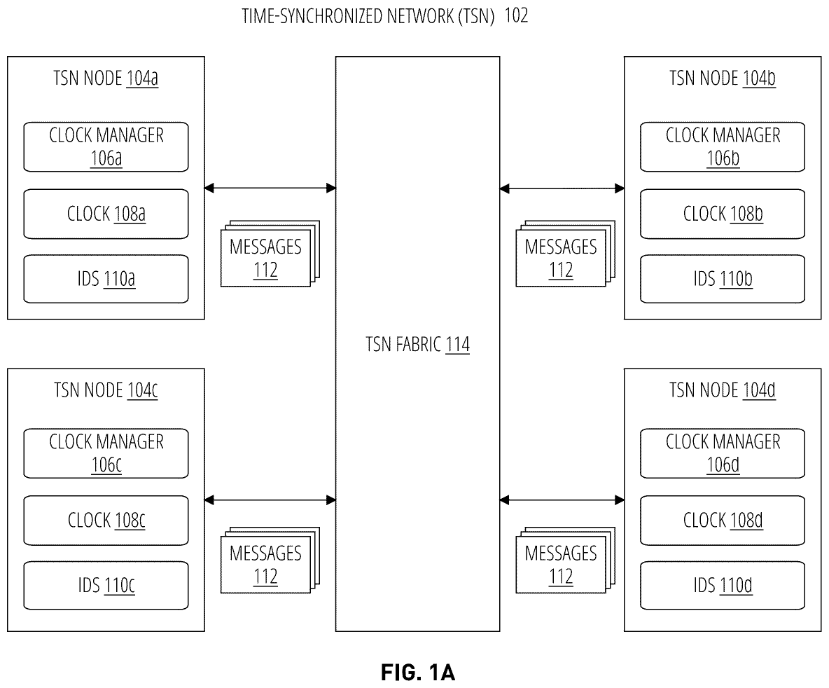

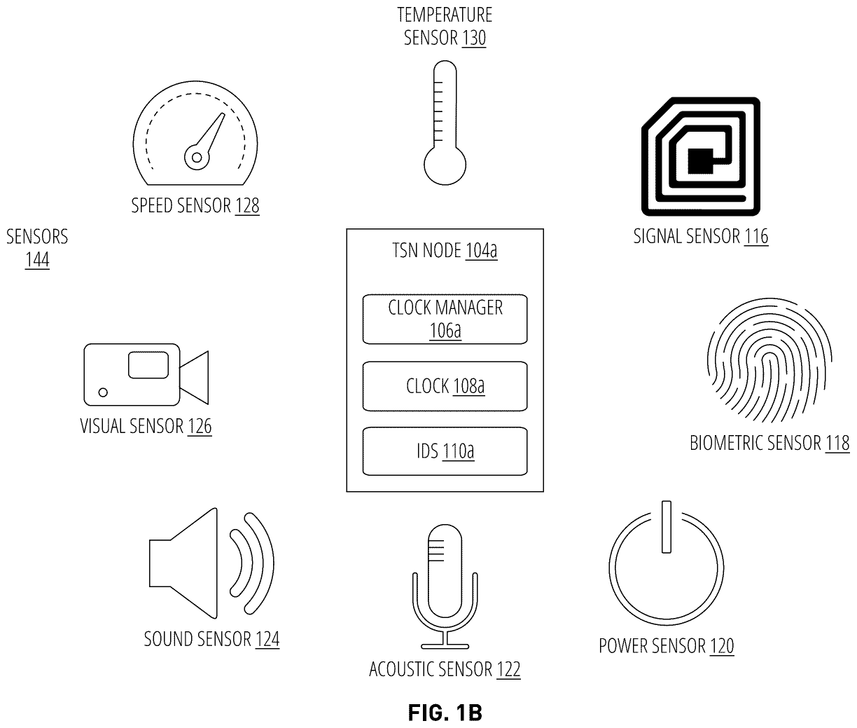

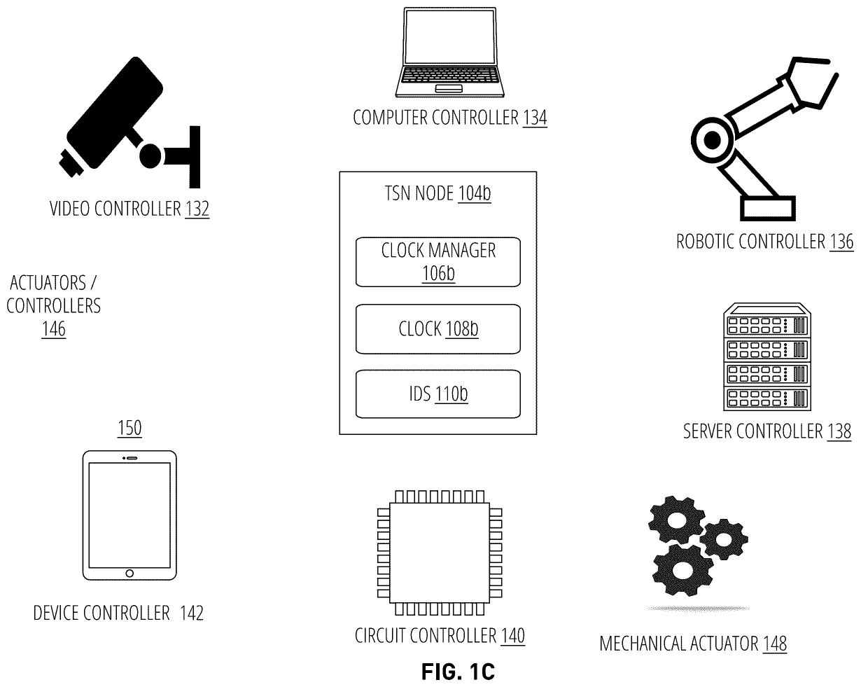

FIG. 1A depicts an exemplary time-synchronized network (TSN) 102 implemented according to a TSN standard (e.g., IEEE 1588, IEEE 802.1AS, IEEE 802.1Qbv, or the like). As depicted, TSN 102 includes various TSN nodes 104, such as TSN nodes 104a-d. The TSN nodes 104 may be implemented as different types of nodes for a TSN, such as an origination node, relay node, switch node, end node, talker node, listener node, diagnostic stream producer, diagnostic stream consumer, and so forth. The TSN nodes 104a-d are communicatively coupled via a TSN fabric 114. The TSN fabric 114 can connect the TSN nodes 104a-d using various types of network topology (e.g., mesh, star, etc.) and various types of communications channels (e.g., wired, wireless, fiber optic, buses, etc.). It is noted that the number of nodes in the TSN 102 is selected for purposes of clarity and not limitation. In practice, the TSN 102 can include any number and combination of nodes (e.g., origination nodes, switches, relay nodes, end devices, etc.).

The TSN nodes 104 can communicate with each other via the TSN fabric 114. For instance, the TSN nodes 104 can send messages 112 to each other over one or more communication channels provided by the TSN fabric 114. The messages 112 can include control information and payload information. One type of control information may include time information. The time information may comprise synchronization messages, time update messages or time follow-up messages (among other time protocol messages) for a time protocol used by the TSN 102.

Each TSN node 104 in the TSN 102 includes various hardware and/or software components. As depicted in FIG. 1A, a TSN 104 includes a clock manager 106, a clock 108 and an intrusion detection system (IDS) 110 (referred to herein as an “IDS” or “detector”). For instance, the TSN node 104a includes a clock manager 106a, a clock 108a and an IDS 110a. The TSN node 104b includes a clock manager 106b, a clock 108b and an IDS 110b. The TSN nodes 104c, 104d are similarly configured. It may be appreciated that these are just a few components for a TSN 104, and the TSN 104 can include other standard components for an electronic device, such as network interfaces, radio transceivers, input/output (I/O) components, memory units, processing circuits, controllers, sensors, actuators, mechanical parts, application software, operating system software, TSN-enabled platforms, and so forth.

In various embodiments, the clock manager 106 is implemented as a software component, and the clock 108 is implemented as a hardware component (e.g., “hardware clock” or “clock circuitry”). The IDS 110 can be implemented as a software component, a hardware component, or a combination of both software and hardware components. Embodiments are not limited in this context.

The clock manager 106 generally manages a time (e.g., clock signals) generated by the clock 108. A key component in clock synchronization mechanisms is the clock manager software. In a time-synchronized network such as the TSN 102, this component tightly interacts with network hardware (e.g., Ethernet/Wi-Fi) to obtain Precision Time Protocol (PTP) message timestamps, as well as with PTP clock hardware to implement suitable phase/frequency corrections in order to synchronize with a clock leader. The clock manager 106 typically implements a “clock servo.” A clock servo is a control algorithm that periodically takes as input some measurement (or estimate) of clock offset to a reference clock, and computes as output either time (e.g., phase) or frequency adjustment to compensate for the given offset.

The clock 108 is generally a hardware clock that implements clock circuitry to generate signals for digital electronics implemented by the TSN node 104. In electronics and especially synchronous digital circuits, a clock signal oscillates between a high and a low state and is used to coordinate actions of the digital circuits. A clock signal is produced by a clock generator. Although more complex arrangements are used, the most common clock signal is in the form of a square wave with a 50% duty cycle, usually with a fixed, constant frequency. Circuits using the clock signal for synchronization may become active at either the rising edge, falling edge, or, in the case of double data rate, both in the rising and in the falling edges of the clock cycle. The clock 108 generates clock signals under control of the clock manager 106. The clock 108 can be implemented using any suitable hardware having a timing accuracy required by a given device or network. In the TSN 102, the clock 108 can be implemented as a PHC, although other hardware clocks can be implemented as well. Embodiments are not limited in this context.

In normal operation, a network interface (not shown) for a TSN node 104 can receive messages 112 that include time information representative of a network time for the TSN 102. The clock manager 106 can receive the time information from the network interface, analyze the time information, and determine whether time adjustments are needed for the clock 108. When time adjustments are needed, the clock manager 106 generates control information and sends the control information to the clock 108. The clock 108 receives the clock manager control information, and adjusts a parameter for the clock 108, such as a phase or frequency for the clock signals generated by the clock 108.

The IDS 110 generally monitors the clock manager 106 to detect abnormal or malicious behavior of the TSN 102. In general, the IDS 110 is a device or software application that monitors a device, network or systems for malicious activity or policy violations. The IDS 110 may be specifically tuned to detect a timing attack, such as a desynchronization attack, or other TSN specific attack vector. Any intrusion activity or violation is typically reported either to other devices in the same network, an administrator, and/or collected centrally using a security information and event management (SIEM) system. A SIEM system combines outputs from multiple sources and uses alarm filtering techniques to distinguish malicious activity from false alarms. In addition to the TSN node 104, the IDS 110 may be implemented for other devices in the TSN, such as relay nodes 104a-104c, to provide a more comprehensive security solution against attacks.

The IDS 110 can operate in an on-line or off-line mode. When operating in an on-line mode, the IDS 110 examines network traffic in real time. It performs an analysis of passing traffic on the entire subnet, and matches the traffic that is passed on the subnets to the library of known attacks. For instance, it analyses the message 310 (e.g., a TSN timing message) and applies some rules, to decide if it is an attack or not. Off-line mode typically deals with stored data and passes it through some processes to decide if it is an attack or not. For the offline case, a message may be replicated for offline analysis. It may be replicated in hardware without incurring a memory copy. However, a software solution may copy the message from the queue for later analysis. In either mode, once an attack is identified, or abnormal behavior is sensed, an alert can be sent to a SIEM, a network administrator, or a software application to automatically implement security protocols, such as dropping the message 112, isolating an infected device guarded by the IDS 110, and/or re-configuring one or more network paths for impacted devices in the TSN network.

The IDS 110 can utilize any number of different methods to detect an attack. For instance, the IDS 110 may implement a signature-based method, a statistical anomaly-based method, a stateful protocol analysis method, machine-learning based, or some combination of all four methods. A signature-based IDS monitors packets in the network and compares with pre-configured and pre-determined attack patterns known as signatures. A statistical anomaly-based or machine-learning based IDS monitors network traffic and compares it against an established baseline. The baseline will identify what is “normal” for that network, such as what sort of bandwidth is generally used and what protocols are used. A stateful protocol analysis IDS identifies deviations of protocol states by comparing observed events with defined profiles of generally accepted definitions of benign activity. It will be appreciated that these detection methods are by way of example and not limitation. Other embodiments may use different detection methods as well. The embodiments are not limited in this respect.

FIG. 1B illustrates an example of a TSN node 104a of the TSN 102 designed to control one or more sensors 144. As depicted in FIG. 1B, the TSN node 104 manages various types of sensors 144, such as a signal sensor 116, a biometric sensor 118, a power sensor 120, an acoustic sensor 122, a sound sensor 124, a visual sensor 126, a speed sensor 128, a temperature sensor 130, and so forth. The TSN node 104a may be suitable for implementing a physics-based model for the IDS 110. A physics-based approach as proposed herein utilizes state prediction based on physical models of system dynamics. Unlike conventional information-based security measures, the physics-based model may utilize physical properties of a system, along with controller state estimation, to enable computationally-inexpensive analytical redundancy. For example, a mathematical model-based replica of the system is simultaneously executed to detect attacks.

FIG. 1C illustrates an example of a TSN node 104b of the TSN 102 designed to control one or more actuators and/or host controllers 146. As depicted in FIG. 1C, the TSN node 104b manages various types of actuators/controllers 146, such as a robotic controller 136, a server controller 138, a mechanical actuator 148, a circuit controller 140, a device controller 142, a video controller 132, a computer controller 134, and so forth. As with FIG. 1B, the TSN node 104b shown in FIG. IC may be suitable for implementing a physics-based model for the IDS 110, as discussed in more detail herein.

In time-synchronized networks, such as the TSN 102 depicted in FIGS. 1A-1C, it becomes important for all the TSN nodes 104 to synchronize to a common or shared network time for the TSN 102. For instance, the TSN nodes 104 may operate in accordance with IEEE 802.1AS which implements a hierarchical network to synchronize one or more clock follower (CF) nodes to a clock leader (CL) node (e.g., a grand CL) through relay nodes or switch nodes. Synchronization is performed through communication of time messages, such as the messages 112. The time messages may comprise, for example, time synchronization messages, time update messages and/or time follow-up messages for a PTP.

In some cases, an attacker may simply attempt to disrupt timing of a single TSN node 104 handling critical functions, such as disrupting one or both of the TSN node 104a managing the sensors 144 and/or the TSN node 104b managing the actuators/controllers 146. Rather than attempting to disrupt timing for the entire TSN 102, the attacker may attempt to attack timing of a single TSN node 104 to disrupt key operations for the TSN node 104, such as an electronic control unit (ECU) to control speed sensing for a vehicle or a controller for a robotic arm in a factory.

In other cases, an attacker may attempt to disrupt timing across the entire TSN 102. To attack or disrupt the TSN 102, an attacker may attempt a timing attack or desynchronization attack to compromise timing for one or more of the TSN nodes 104 in the TSN 102. Assume the TSN node 104c operates as a clock leader (CL) in the TSN 102, and the TSN node 104d operates as a clock follower (CF) in the TSN 102. If an attacker located on a network device (e.g., switch or relay) modifies a critical attribute on a specific port, then all downstream nodes from that network device may suffer a desynchronization event. In this example, if the attacker successfully compromises the TSN node 104c, then the TSN node 104d is vulnerable to a timing attack in the form of receiving messages 112 from the TSN node 104c with erroneous time information. Therefore, it becomes important to detect and localize an attack as quickly as possible. Furthermore, upon detection, it becomes important for the TSN 102 to quickly isolate the compromised network device and thereby prevent the desynchronization attack from spreading to other downstream nodes.

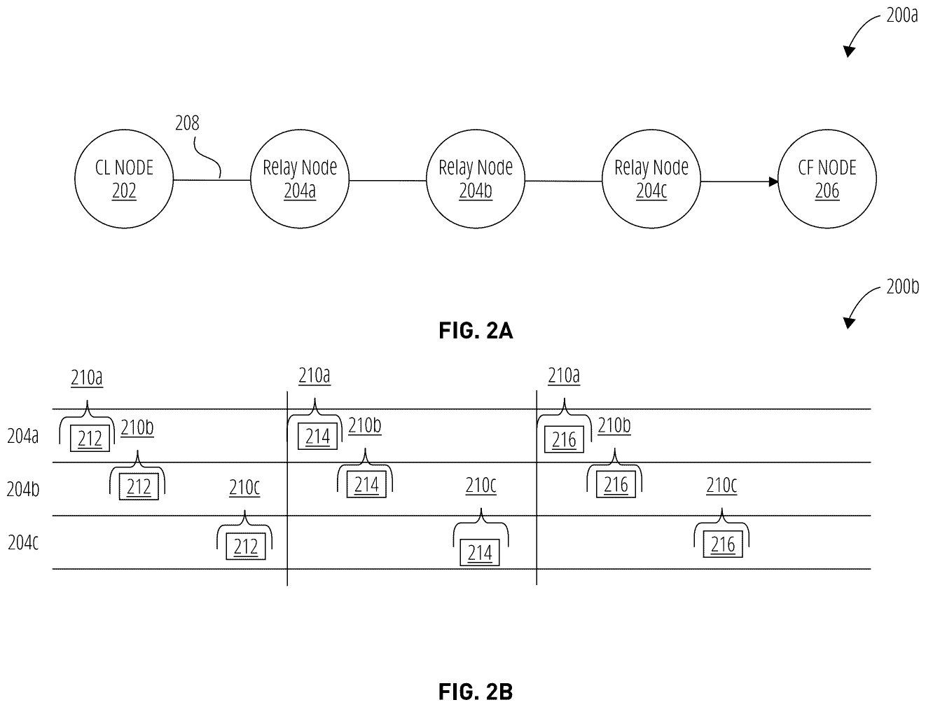

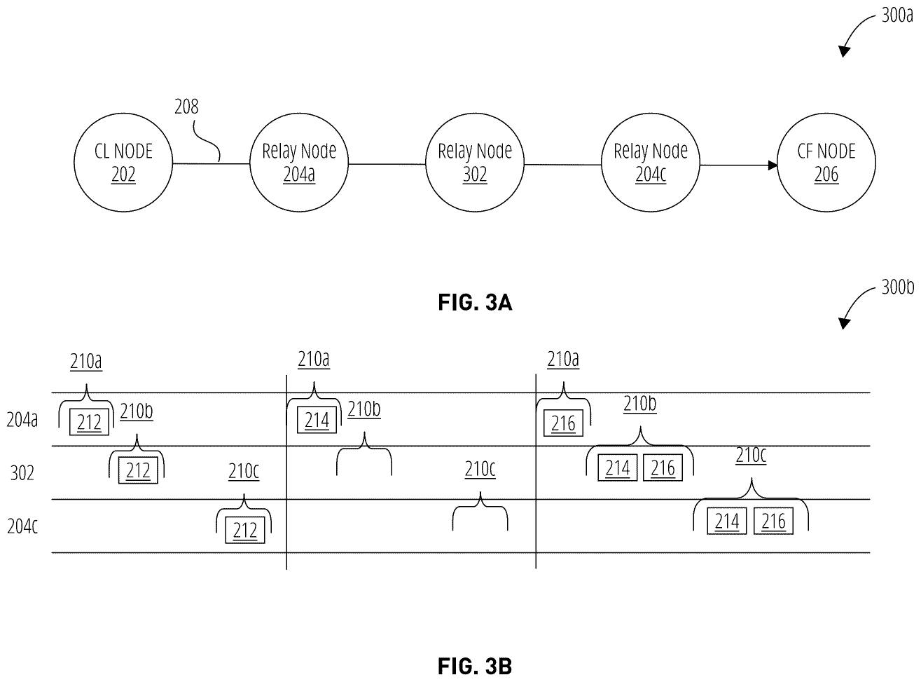

In all cases, a time-synchronized network such as the TSN 102 is vulnerable to a timing attack or a desynchronization attack. If a single network node is compromised, it may cause a cascade failure across the entire TSN 102. An example of such an attack is further described with reference to FIGS. 2A, 2B, 3A and 3B.

FIG. 2A depicts a TSN 200a implemented according to a TSN standard (e.g., IEEE 1588, IEEE 802.1AS, IEEE 802.1Qbv, or the like). As depicted, the TSN 200a includes clock leader node 202, relay nodes 204a, 204b, and 204c, and clock follower node 206, all communicatively coupled via communication channel 208. The clock leader node 202 and the clock follower node 206 have a “master/slave” relationship, where the clock leader node 202 is treated as a “master” device and the clock follower node 206 is treated as a “slave” device. The clock leader node 202 includes a clock that maintains a network time for the TSN 102. The clock follower node 206 includes a clock that synchronizes a clock to the network time via one or more of the messages 112. Alternatively, nodes of the network may be implemented as a “talker node” and a “listener node”, respectively. This configuration refers to data transmission, where the talker node transmits data and the listener node listens or receives data. This configuration is used, for example, in scheduled traffic.

Relay nodes 204a, 204b, and 204c are time-aware switching nodes and can be any number of devices in a network arranged to communicate information. A clock leader node 202 sends or originates information and a clock follower node 206 receives or consumes information. Examples of a clock leader node 202 or a clock follower node 206 include devices such as electronic control units in an autonomous vehicle, an industrial system, a medical system, or the like. Additionally, communication channel 208 can be any of a variety of communication channels, including wired or wireless communication channels. In some implementations, all devices in the TSN 200a will receive gate control list (GCL) tables. However, in some implementations, only clock leader nodes 202 and switching nodes (e.g., relay node 204a, etc.) receive GCL tables while destination devices (e.g., clock follower node 206) do not receive a GCL table.

FIG. 2B depicts a timing diagram 200b depicting communication windows (e.g., Qbv windows, or the like) for switches of TSN 200a based on GCL tables. Typically, GCL tables are generated in a network controller (not shown) and are designed to prioritize time critical (TC) traffic and prevent lower priority traffic from accessing communication channel 208, thus guaranteeing the timely delivery of TC packets within pre-configured time windows. In particular, timing diagram 200b depicts Qbv windows 210a, 210b, and 210c in which packets 212, 214, and 216 are transmitted. It is noted that the communication windows referred to herein are referred to as Qbv windows or protected windows for clarity. However, other standard or techniques for forming protected communication windows to facilitate time synchronization can be used besides Qbv windows. Examples are not limited in this context.

To facilitate transmission of packets (e.g., packet 212, etc.) during protected windows (e.g., Qbv window 210a, etc.), nodes in the TSN 200a are time synchronized and scheduled to transmit TC packets (e.g., packet 212, etc.) using non overlapping protected windows (e.g., Qbv window 210a, etc.). It is to be appreciated that providing latency bounded communication (e.g., as depicted in timing diagram 200b) requires tight synchronization of time between nodes in TSN 200a. With such dependency on time synchronization, reliable TSN operation can be disrupted by attacking the timing of the network, sometimes referred to as a desynchronization attack or event.

FIG. 3A depicts a TSN 300a, which is like TSN 200a except that the relay node 302 is depicted as compromised. In particular, the clock (not shown) of relay node 302 can be attacked and compromised, thereby causing the Qbv window 210b associated with relay node 302 to be misaligned with respect to, and even overlap with, the protected windows of the other switch nodes in the data stream path (e.g., along communication channel 208).

FIG. 3B depicts timing diagram 300b illustrating Qbv window 210b misaligned with Qbv window 210a and Qbv window 210c and overlapping with Qbv window 210a. As such, packets (e.g., packet 214 in the figure) arrive too late with respect to the attacked switch protected window (e.g., Qbv window 210b) causing them to be buffered and sent in the next protected window, or alternatively, dropped completely. As a result of the delay in transmitting packet 214, relay node 302 breaks the latency bound of the stream that it is serving and can result in errors or comprise the safety of the system in which the nodes are operating

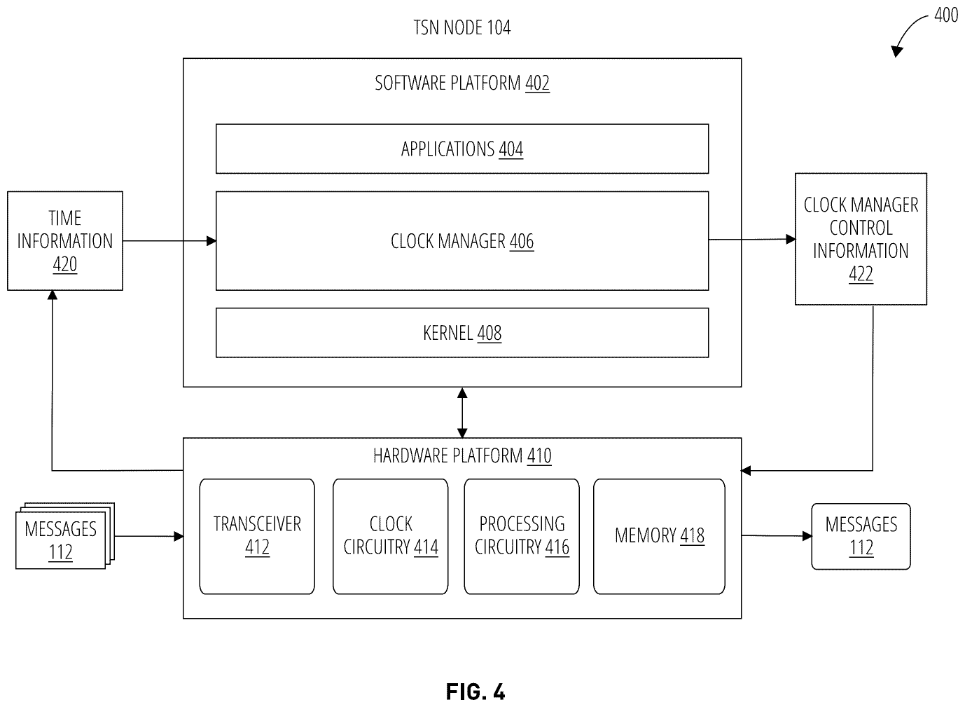

FIG. 4 illustrates a more detailed view of a TSN node 104 that implements one or more TSN protocols or standards. The TSN node 104 may be implemented as any network devices suitable for operation within a TSN, such as TSN 102, 200a, 300a, and so forth. The TSN node 104 may be implemented as part of a vehicle, robot, industrial machine or any other devices suitable for a TSN. The TSN node 104 may be implemented as an origination node 202, relay nodes 204a-204c, relay node 302 and/or end node 206. The TSN node 104 may be implemented as either a clock leader (CL) or a clock follower (CF) in a TSN. The TSN node 104 may include interfaces to communicate information with other TSN nodes 104 in the TSN 102, such as messages 112, for example.

The TSN node 104 may operate in accordance with a timing protocol, such as a precision time protocol (PTP) for IEEE 1588, IEEE 802.1AS, and so forth. For instance, the TSN node 104 may operate in accordance with IEEE 802.1AS which implements a hierarchical network to synchronize clock followers (CFs) to a clock leader (CL) through relays or switch nodes. Synchronization is performed through communication of time messages, such as the messages 112. The time messages may comprise, for example, time synchronization messages, time update messages or time follow-up messages (among others) for a PTP. The time messages may include, among other fields and attributes, a correction field, which accumulates a network residence, and an origin timestamp for a CL. The time message may also comprise, for example, a packet delay message type with additional fields and attributes.

As depicted in FIG. 4, the TSN device 104 may include a software platform 402 and a hardware platform 410. The software platform 402 may include, among other software components, one or more applications 404, a clock manager 106, and a kernel 408. The hardware platform 410 may include, among other hardware components, a network interface such as a transceiver 412, clock circuitry 414, processing circuitry 416 and memory 418.

The processing circuitry 416 may include circuitry or processor logic, such as, for example, any of a variety of commercial processors. In some examples, the processing circuitry 416 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processing circuitry 416 may include graphics processing portions and may include dedicated memory, multiple-threaded processing and/or some other parallel processing capability. In some examples, the processing circuitry 416 may be an application specific integrated circuit (ASIC) or a field programmable integrated circuit (FPGA). In some examples, the processing circuitry 416 may be circuitry arranged to perform computations related to TSN, such as switching, clock leader, clock follower, routing, security, and so forth.

The memory 418 may include logic, a portion of which includes arrays of integrated circuits, forming non-volatile memory to persistently store data or a combination of non-volatile memory and volatile memory. It is to be appreciated, that the memory 418 may be based on any of a variety of technologies. In particular, the arrays of integrated circuits included in memory 408 may be arranged to form one or more types of memory, such as, for example, dynamic random access memory (DRAM), NAND memory, NOR memory, or the like.

The transceiver 412 may include logic and/or features to support a communication interface. For example, the transceiver 412 may include one or more interfaces that operate according to various communication protocols or standards to communicate over direct or network communication links. Direct communications may occur via use of communication protocols or standards described in one or more industry standards (including progenies and variants). For example, the transceiver 412 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. In some examples, transceiver 412 may be arranged to support wireless communication protocols or standards, such as, for example, Wi-Fi, Bluetooth, ZigBee, LTE, 5G, or the like.

The TSN node 104 may also include where the network is a controller area network (CAN) or a vehicle area network (VAN). The TSN node 104 may be implemented as a device that manages a sensor, actuator or a controller. The sensors may comprise a speed sensor, a direction sensor, a global positioning system (GPS) sensor, a gas pedal sensor, a brake pedal sensor, a positioning sensor, an object detection sensor, a lane detection sensor, a radar sensor, a light detection and ranging (LIDAR) sensor, an ultrasound sensor, an inertial measurement unit (IMU) sensor, a temperature sensor, a pressure sensor, an altitude sensor, an acoustic sensor, and so forth.

In one aspect, the TSN node 104 may be implemented as a CL or CF for the TSN 102. As previously discussed, the clock manager 106 may ensure that the clock circuitry 414 maintains a network time for the TSN 102. When operating in a CL role, the clock manager 106 may send a message 112 with time information 420 representing a current network time to one or more nodes operating in a CF role for the TSN 102. When operating in a CF role, the clock manager 106 may receive a message 112 from a CL node. The clock manager 106 may use the time information 420 from the message 112 to synchronize a local device time with the current network time maintained by the clock circuitry 414. The clock manager 106 analyzes the time information 420, and determines whether to adjust a parameter (e.g., phase or frequency) of the clock circuitry 414 to synchronize the clock circuitry 414 to the current network time.

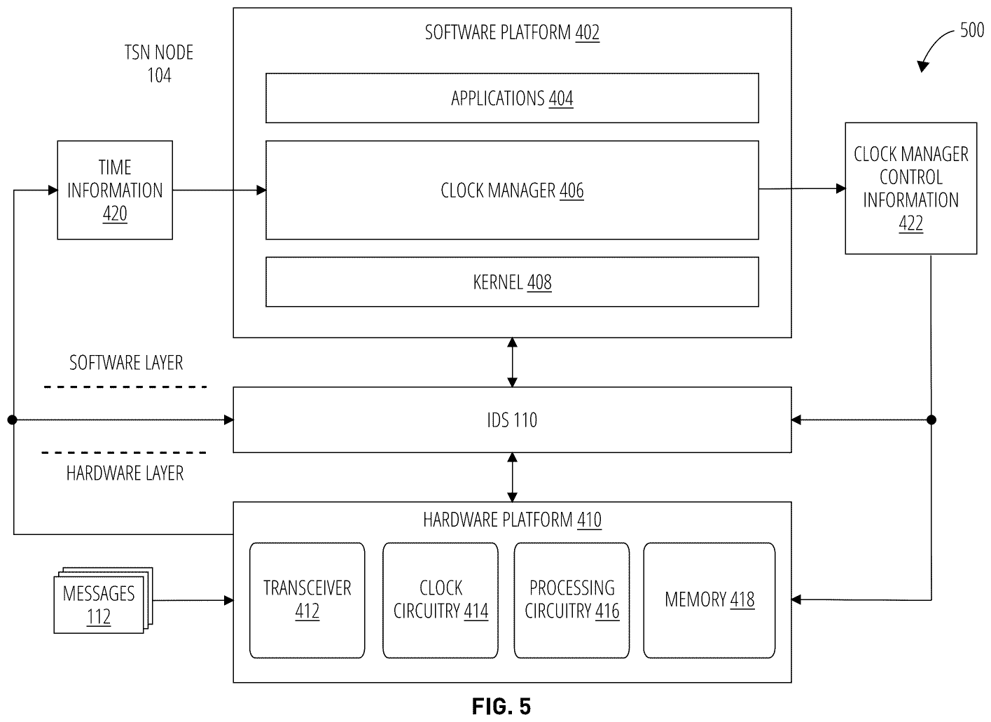

FIG. 5 illustrates an apparatus 500. Similar to the apparatus 400, the apparatus 500 includes a software platform 402 and a hardware platform 410. In addition, the apparatus 500 includes an IDS 110 to monitor a clock manager 106 of the software platform 402. As previously discussed, the IDS 110 generally monitors the clock manager 106 to detect abnormal or malicious behavior of the clock manager 106. More particularly, the IDS 110 monitors the inputs and/or outputs of the clock manager 106, such as consuming the time information 420 sent from the transceiver 412 to the clock manager 106 as input, and the clock manager control information 422 sent from the clock manager 106 to the clock circuitry 414 as output.

As depicted in FIG. 5, the apparatus 500 includes a clock circuitry 414 to implement a hardware clock (e.g., a PHC) for a device, such as a TSN node 104. The apparatus 500 includes a processing circuitry 416 coupled to the clock circuitry 414, the processing circuitry 416 to execute instructions to perform operations for a clock manager 106. The clock manager 106 is operative to receive messages 112 with time information 420 for a network, such as TSN 102. The clock manager 106 generates clock manager control information 422 to adjust the clock circuitry 414 to a network time for the TSN 102. The clock manager control information 422 may comprise one or more parameters to adjust the clock circuitry 414 for the apparatus 500. The one or more parameters may represent, for example, adjustments to a phase or frequency of the clock circuitry 414. For example, the clock manager control information 422 may comprise a phase or frequency adjustment based on a time offset between a reference time and a time maintained by the clock circuitry 414. The reference time is based on the time information 420 in at least one message 112.

The apparatus 500 further includes an IDS 110 coupled to the processing circuitry 416 and the clock circuitry 414. In one embodiment, the IDS 110 may be implemented as part of a software layer for the apparatus 500, such as the software platform 402. In another embodiment, the IDS 110 may be implemented as part of a hardware layer for the apparatus 500, such as the hardware platform 410. In yet another embodiment, certain elements of the IDS 110 may be implemented in the software platform 402, while other elements of the IDS 110 may be implemented in the hardware platform 410. Embodiments are not limited in this context.

Although FIG. 5 depicts the IDS 110 implemented as part of the apparatus 500, it may be appreciated that the IDS 110 may be implemented by another apparatus, device or system communicatively coupled to the apparatus 500. For instance, the IDS 110 may be implemented as part of an IDS for the apparatus 500 that is separate from the apparatus 500 or a device other than a device that implements the apparatus 500. For instance, if the apparatus 500 is implemented by a TSN node 104a, the IDS 110 of the apparatus 500 could optionally be implemented in a TSN node 104b. The IDS 110 could also be implemented by an IDS communicatively coupled to the TSN node 104, either directly via a wired or wireless connection, or indirectly via the TSN fabric 114. Embodiments are not limited in this context.

The IDS 110 is operative to consume multiple types of information to detect a security attack. For instance, the IDS 110 can receive and analyze messages 112 for a TSN node implementing the software platform 402 and/or the hardware platform 410. The messages 112 may carry time information for a TSN node, such as an origin time, resident time, link delays, among other types of clock information. The messages 112 may comprise, for example, synchronization messages, reference synchronization messages, or “FollowUp” messages. The TSN node retrieves or decodes the time information from the messages 112, and utilize the time information to synchronize an internal local clock with a network time issued by a clock leader or grand clock leader. The IDS 110 can also receive and analyze other types of information, such as clock manager control information 422 in transit from the clock manager 106 of the software platform 402 and the hardware platform 410. For instance, the IDS 110 can consume software control messages, or it can have one or more taps on a hardware bus or signal lines used to communicate electrical signals to the hardware platform 410. The IDS 110 analyzes the messages 112 and/or other types of information, and determines whether to generate an alert or take corrective action for the apparatus 500 based on results of the analysis.

The messages 112 are communicated between TSN nodes at a certain frequency or rate which can be measured in a number of messages sent or received per unit of time, such as a number of messages sent per second. This is referred to herein as a “message frequency.” The message frequency for transmission of the messages 112, which carry origin time (Sync/FollowUp) and link delay computation (LDC), is typically dependent on the latency requirements of a time-sensitive application. The message frequency is usually calculated during a design phase for a TSN, taking into account a variety of factors, and instantiated during initialization of a TSN or individual TSN nodes.

In a TSN, the message frequency to update time, or time synchronization (TSYNC), can vary based on the specific requirements of the network, the type of applications it supports, and the specific standards to which it adheres. However, for the purpose of maintaining synchronization across devices and systems, the time is typically updated at very short intervals, often ranging from microseconds to milliseconds. For instance, in networks that adhere to IEEE 802.1AS, which is a standard for timing and synchronization for time-sensitive applications in bridged and virtual bridged local area networks, the synchronization could be maintained by exchanging timing messages at intervals that ensure the network and devices remain closely synchronized. The exact interval can depend on the network configuration, latency requirements, and the precision of the time synchronization needed for the applications running on the network. In one embodiment, for example, the TSYNC value could be 125 ms. Embodiments are not limited to this example.

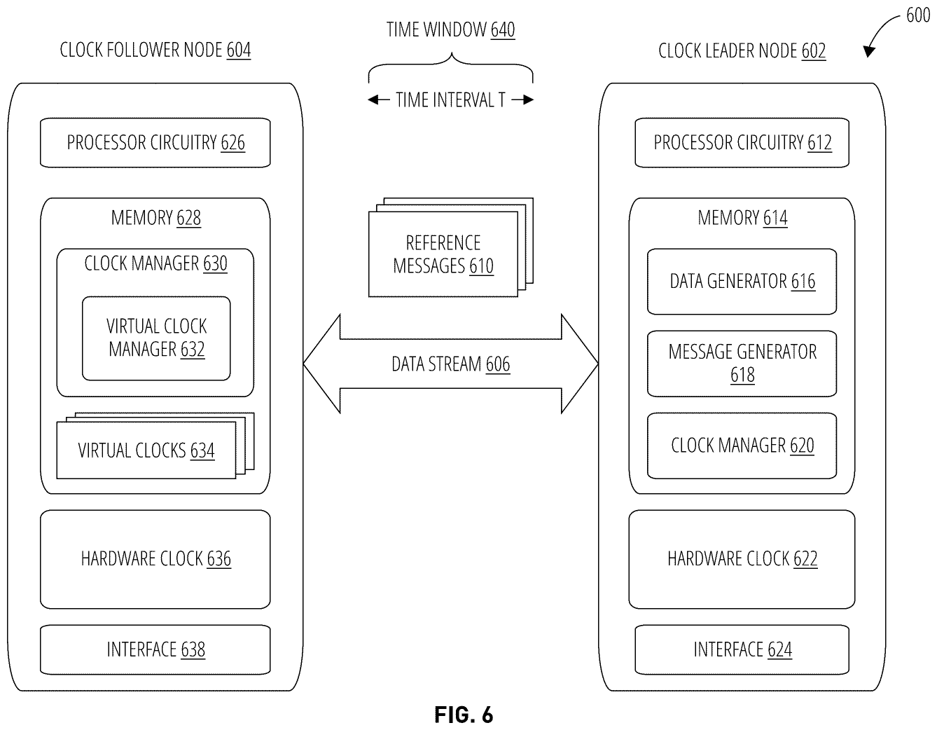

FIG. 6 illustrates a system 600 suitable for a TSN, such as the TSN 102, for example. As depicted in FIG. 6, the system 600 may include a clock leader node 602 and a clock follower node 604. In one embodiment, for example, the clock leader node 602 and the clock follower node 604 are both TSN nodes 104 within the TSN 102. While system 600 depicts a single clock leader node 602 and a single clock follower node 604 for purposes of clarity, it may be appreciated that the system 600 can implement multiple clock leader nodes 602 and clock follower nodes 604. Embodiments are not limited in this context.

In general operation, the clock leader node 602 may produce various types of information that may be communicated to the clock follower node 604 over various communications channels implemented by the TSN 102. In one embodiment, for example, the clock leader node 602 may send data traffic via a data stream 606. A data stream 606 may communicate data information for a TSN node via one or more messages 112. For example, the data information may comprise normal TSN and regular data traffic, such as control information, application information, management information, timing information, protocol information, and so forth. In one embodiment, for example, the data stream 606 may periodically communicate timing information for a TSN node via one or more reference messages 610.

In one embodiment, for example, a clock leader node 602 such as a TSN node 104 may be implemented, at least in part, by a computing apparatus that includes processor circuitry 612, memory 614 and an interface 624. The memory 614 may be communicatively coupled to the processor circuitry 612 and the interface 624. The memory 614 may store instructions that when executed by the processor circuitry 612, causes the processor circuitry 612 to perform one or more operations for the clock leader node 602. Additionally, or alternatively, the operations may be executed by dedicated hardware (e.g., DSP, ASIC, FPGA, circuitry, etc.), or a combination of hardware and software. Embodiments are not limited in this context.

The processor circuitry 612 may execute instructions for a data generator 616. The data generator 616 may prepare a data stream 606 for transmission from the clock leader node 602 to a clock follower node 604 within a time window 640, such as according to a time schedule distributed by a CNC (e.g., an IEEE 802.Qbv time window), assigned to the clock leader node 602 in a TSN 102. The data generator 616 may determine an amount of transmit time needed to send the data stream 606 from the clock leader node 602 to the clock follower node 604 during the time window (e.g., an IEEE 802.Qbv time window) assigned to the clock leader node 602.

The processor circuitry 612 may execute instructions for a message generator 618. In general, the message generator 618 may generate one or more reference messages 610 for a given TSN node 104. Each of the reference messages 610 may carry time information 420 from a hardware clock 622 that maintains a network time for the TSN 102. The clock leader node 602 generates and transmits the reference messages 610 according to a message frequency defined by a reference synchronization interval, such as a TSYNC value. For example, the TSYNC value may be set for 125 ms at a design time for the TSN 102. The TSYNC value may be set to any suitable value for a given TSN 102 and/or TSN applications executing on a TSN node 104. Embodiments are not limited in this context.

The processor circuitry 612 may execute instructions for a clock manager 620. The clock manager 620 may perform operations similar to the clock manager 406 as described with reference to FIG. 4 and/or FIG. 5. The clock manager 620 manages clock operations for the hardware clock 622. The hardware clock 622 maintains a network time for the TSN 102.

In one embodiment, for example, a clock follower node 604 such as a TSN 104 may be implemented, at least in part, by a computing apparatus that includes processor circuitry 626, memory 628 and an interface 638. The memory 628 may be communicatively coupled to the processor circuitry 626 and the interface 638. The memory 628 may store instructions that when executed by the processor circuitry 626, causes the processor circuitry 626 to perform one or more operations for a clock follower node 604. Additionally, or alternatively, the operations may be executed by dedicated hardware (e.g., DSP, ASIC, FPGA, circuitry, etc.), or a combination of hardware and software. Embodiments are not limited in this context.

The processor circuitry 626 may execute instructions for a clock manager 630. The clock manager 630 may perform operations similar to the clock manager 406 as described with reference to FIG. 4 and FIG. 5. The clock manager 630 manages clock operations for the hardware clock 636. For example, the clock manager 630 adjusts timing operations for the hardware clock 636 in response to time information 420 carried by the reference messages 610 to synchronize the hardware clock 636 of the clock follower node 604 with the hardware clock 622 of the clock leader node 602.

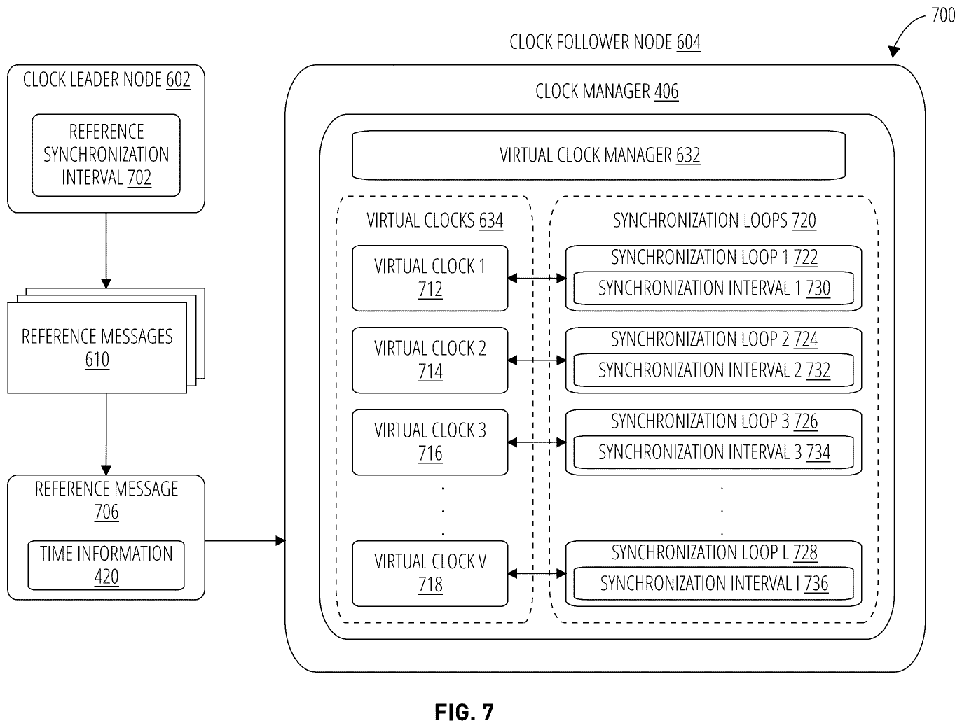

In various embodiments, the clock manager 630 may include a virtual clock manager 632. The virtual clock manager 632 is responsible for managing a set of virtual clocks 634 for the clock follower node 604. The virtual clocks 634 are software versions of the hardware clock 636. The virtual clock manager 632 adjusts timing operations for each of the virtual clocks 634 in response to time information 420 carried by the reference messages 610 to synchronize the virtual clocks 634 of the clock follower node 604 with the hardware clock 622 of the clock leader node 602. Specifically, the virtual clock manager 632 adjusts timing operations for each of the virtual clocks 634 in accordance with a synchronization loop assigned to each of the virtual clocks 634. Each synchronization loop has a corresponding synchronization interval that is different from the TSYNC value used to control a transmit frequency of the reference messages 610. In one embodiment, for example, each synchronization loop for the set of virtual clocks 634 may have a synchronization interval that is a multiple of the TSYNC value, such as 2×TSYNC, 3×TSYNC, 4×TSYNC, and so forth. This concept is further described with reference to FIG. 7.

One conventional solution to address network attacks is to implement one or more IDS, such as IDS 110, to monitor TSN nodes of the TSN 102 to identify any abnormal behavior. An IDS implements software, firmware or hardware to support one or more specialized security functions, such as detecting malicious behavior caused by an attacker. The IDS may be implemented on a TSN node or separate from a TSN node. The IDS receives as input messages containing time information for synchronizing a clock of a TSN node with a network time for the TSN. The IDS analyzes the messages to detect anomalies, such as slight modifications to the time information to cause a TSN node to update an internal clock with a wrong network time. Incorrect time synchronization can cause disruptions in time sensitive applications executing on the TSN node, such as causing collisions between cooperative robotic arms or delaying braking in an autonomous vehicle. When the IDS detects abnormalities in messages carrying time information, the IDS generates an alert and takes action to isolate any affected TSN applications and/or TSN nodes from a compromised TSN node.

As previously discussed, once a TSN node receives an alert for an attack it may have already consumed compromised messages carrying erroneous time information. The clock follower node 604 in the TSN 102 has a clock manager 630 (e.g., a clock servo or controller) driving a hardware clock 622 or a set of virtual clocks V towards a zero-offset to a clock leader node 602. The clock follower node 206 performs time synchronization using a fixed-rate process that includes a repetitive and continuous sensing, controlling, and actuation cycle. The clock manager 630 performs time offset sensing based on reference messages 610 carrying time information 420, clock adjustment computations based on the time information 420, and clock adjustments to the hardware clock 636 based on the clock adjustment computations (e.g., phase or frequency adjustments). The fixed-rate process repeats once every synchronization cycle as defined by a reference synchronization interval (e.g., TSYNC).

Since the clock manager 630 for the clock follower node 604 continuously repeats the fixed-rate process every TSYNC, even a SOTA IDS, such as IDS 110, is capable of detecting network attacks only after the clock follower node 604 has already consumed one or more compromised samples. In such cases, the clock follower node 604 may have already updated its hardware clock 636 with the erroneous time information 420 and desynchronized from a network time for the TSN 102 as maintained by the hardware clock 622 of the clock leader node 602.

To solve this problem, the clock follower node 604 implements a solution that provides a clean clock state not influenced by network attacks at the time of detection by the clock follower node 604, even after the clock follower node 604 consumes erroneous time information generated by the attack. Specifically, the clock follower node 604 implements a virtual clock manager 632 that intrinsically enables the time-synchronized system to keep track of a “live” clock that will not be affected by network-based attacks at the moment when the IDS 110 is able to make a decision, which is typically several samples after the attack has commenced. This is achieved by making use of a quantifiable tradeoff between time synchronization QoC and providing security guarantees. At the time the network attack is detected, the virtual clock manager 632 is able to turn to a synchronization loop of slower bandwidth for a virtual clock that has not yet consumed the attacked time measurements. Upon detecting a network-based attack targeting the TSN 102, such as inserting bias in the network time measurements used to compute time offset, the clock follower node 604 immediately stops updating a set of virtual clocks 634 from malicious samples, and it accesses a clean clock state (e.g., through a timekeeping application program interface (API)) from a virtual clock that has not been infected. In this manner, the virtual clock manager 632 quickly accesses a clean clock state when anomalous conditions are met.

The IDS 110, with FP/FN rates, may detect network attacks only after several samples have been consumed leaving a contaminated clock state that is unusable by any subsequent recovery mechanism. On the other hand, a virtual clock manager 632 on the clock follower node 604 can maintain multiple clock control loops, referred to as “synchronization loops,” for a set of virtual clocks 634 that are updated at different rates. For instance, if a baseline reference synchronization interval is 125 ms, a set of redundant synchronization loops may be updated at multiples of the reference synchronization interval, such as every k, n, x, and y synchronization intervals (e.g., 250 ms, 500 ms, 750 ms, and 1000 ms). By providing such redundancy in the instances when the network time measurements are consumed, the clock follower node 604 can gain resilience to network-based attacks. Consequently, when an attack is detected, the virtual clock manager 632 can directly read an unaffected virtual clock that has not been updated using malicious time measurements. By doing so, the virtual clock manager 632 is able to trade a small amount of QoC to achieve security guarantees. For instance, if the IDS 110 detects the attack after the clock follower node 604 has already consumed 5 samples, the virtual clock manager 632 for the clock follower node 604 can then initiate a recovery mechanism and pre-load initial conditions (e.g., a current, unaffected time) by reading from a synchronization loop that is designed to update a virtual clock at a synchronization interval that is greater than 5 times a reference synchronization interval (Ts). For example, if Ts=125 ms, then the virtual clock manager selects a synchronization loop for a virtual clock that is greater than or equal to 625 ms (5×125 ms=625 ms). The performance penalty is minimal for at least two reasons. In the benign case, the application is still synchronized to the baseline clock control loop (e.g., the one updated most frequently). In the attack case, the clock manager is able to choose the synchronization loop that is unaffected by the attacker and offers a notion of time that is minimally desynchronized compared to the baseline clock control loop. For example, timekeeping accuracy degrades by only approximately 1 nanosecond (ns) when the clock control loop is updated every 250 ms instead of 125 ms, justifying the tradeoff with security guarantees. The implementation can be based on the standard virtual clock implementation in Linux timekeeping systems (e.g., PTP4L—Precision Time Protocol for Linux). There are no fundamental limitations to the number of redundant clock control loops and the cost of running them is virtually insignificant. An example is illustrated in Table 1 as follows:

TABLE 1

| Sync period | RMS | Std. Dev. |
|---|---|---|
| 125 ms | 19.2166 ns | 19.1528 ns |
| 250 ms | 20.3638 ns | 20.2452 ns |

| | |
|---|---|
| — | Marginal performance degradation |

As illustrated in Table 1, a synchronization period of 125 ms has a root mean square (RMS) of 19.2166 ns and a standard deviation of 19.1528 ns, while a synchronization period of 250 ms has a slightly increased RMS of 20.2638 ns and a standard deviation of 20.2452 ns.

FIG. 7 illustrates a logic diagram 700. The logic diagram 700 is an example of operations for the clock leader node 602 and the clock follower node 604. Specifically, the logic diagram 700 is an example of the virtual clock manager 632 performing continuous synchronization operations for a set of virtual clocks 634 using time information 420 from a set of reference messages 610.

As depicted in the logic diagram 700, the clock leader node 602 periodically sends reference messages 610 (e.g., messages 112) to the clock follower node 604. Each of the reference messages 610 comprise time information 420 to synchronize the hardware clock 636 of the clock follower node 604 with the hardware clock 622 of the clock leader node 602. For example, the clock leader node 602 sends an example reference message 706 from the reference messages 610. The reference message 706 comprises time information 420.

The clock follower node 604 comprises the clock manager 630 to manage the hardware clock 636 of the clock follower node 604. An example of the hardware clock 636 is the clock circuitry 414 of the hardware platform 410. The clock manager 630 updates the hardware clock 636 using the sense, compute, and actuate cycle based on the time information 420.

The clock manager 630 includes a virtual clock manager 632. The virtual clock manager 632 manages a set of virtual clocks 634 including virtual clock 1 712, virtual clock 2 714, virtual clock 3 716, and virtual clock V 718, where V represents any positive integer. The set of virtual clocks 634 correspond to a set of synchronization loops 720 including synchronization loop 1 722, synchronization loop 2 724, synchronization loop 3 726, and synchronization loop L 728, where L represents any positive integer. The synchronization loops 720 each comprise a synchronization interval/including synchronization interval 1 730, synchronization interval 2 732, synchronization interval 3 734, and synchronization interval I 736, where I represents any positive integer.

Each of the virtual clocks 634 are periodically synchronized with time information 420 from reference messages 610. However, all of the virtual clocks 634 are not updated each reference synchronization interval 702. Instead, each of the virtual clocks 634 are part of a synchronization loop L that is designed to synchronize the virtual clocks 634 using different synchronization intervals I. Each synchronization interval is a multiple of the reference synchronization interval 702. By way of example, the synchronization loop 1 722 may control updates to the virtual clock 1 712 using synchronization interval 1 730, the synchronization loop 2 724 may control updates to the virtual clock 2 714 using synchronization interval 2 732, the synchronization loop 3 726 may control updates to the virtual clock 3 716 using synchronization interval 3 734, and the synchronization loop L 728 may control updates to the virtual clock V 718 using the synchronization interval I 736. For example, the synchronization interval 1 730 may comprise a period of time that is twice as long as the reference synchronization interval 702, the synchronization interval 2 732 may comprise a period of time that is five times as long as the reference synchronization interval 702, the synchronization interval 3 734 may comprise a period of time that is eight times as long as the reference synchronization interval 702, and so forth. These are merely examples, and each of the synchronization intervals I may be set to any multiple of the reference synchronization interval 702.

By updating the set of virtual clocks 634 using different synchronization intervals, each of which are a multiple of the reference synchronization interval 702, when the clock follower node 604 is under attack and it consumes one or more samples from reference messages 610 prior to an IDS 110 detecting an attack, a subset of the set of virtual clocks 634 will be compromised. However, a mutually-exclusive subset of the set of the virtual clocks 634 will still retain clean clock states that remain synchronized with the hardware clock 622 of the clock leader node 602, within a time tolerance range as defined by one or more TSN applications dependent on the clock follower node 604. This is because the synchronization intervals are time periods longer (e.g., with slower update times) than the reference synchronization interval 702 between updates.

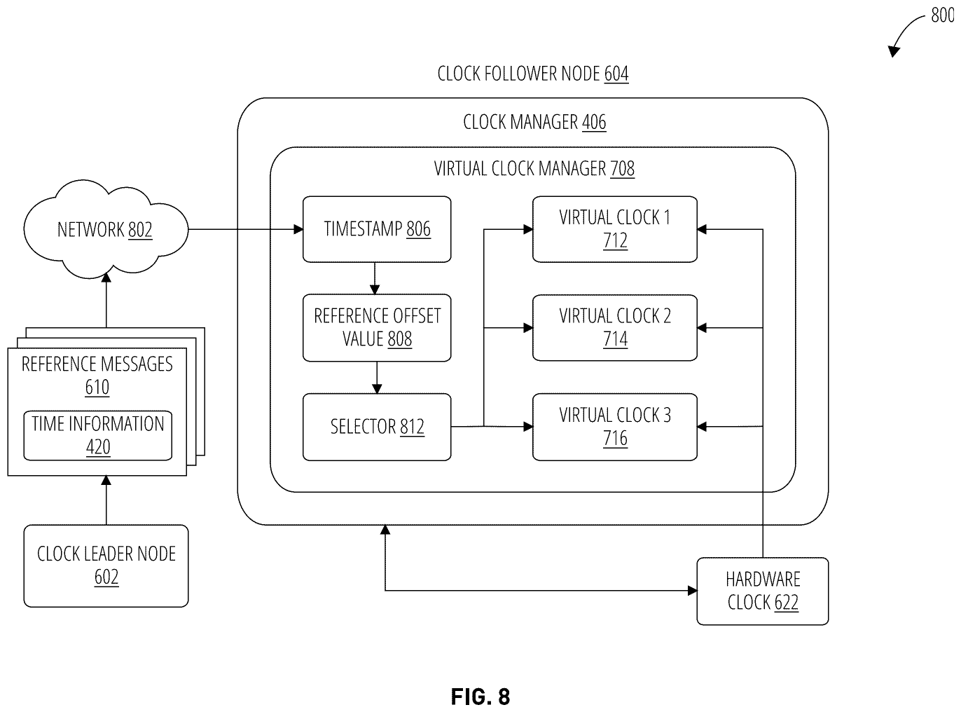

FIG. 8 illustrates a logic diagram 800. The logic diagram 800 is an example of operations for clock follower node 604. Specifically, the logic diagram 800 is an example of the virtual clock manager 632 performing continuous synchronization operations for a set of virtual clocks 634 using time information 420 from a set of reference messages 610.

As depicted in logic diagram 800, the virtual clock manager 632 performs operations comprising receiving reference messages 610 such as a reference message 706 via a network 802. The reference message 706 may include time information 420 to synchronize a hardware clock 636 of a TSN node, such as clock follower node 604, with a network time for a TSN 102 as maintained by the hardware clock 622 of the clock leader node 602. The reference message 706 is associated with a reference synchronization interval 702, which is defined using a TSYNC value. The virtual clock manager 632 performs operations such as selecting a virtual clock, such as a first virtual clock 1 712, from a set of virtual clocks 634 for the clock follower node 604. The first virtual clock 1 712 is associated with a first synchronization interval 1 730 that is different from the reference synchronization interval 702. The virtual clock manager 632 performs operations such as adjusting a time for the first virtual clock 1 712 based on the time information 420 from the reference message 706 to synchronize the first virtual clock 1 712 with the network time for the TSN 102. In one embodiment, for example, the synchronization interval I is a multiple of the reference synchronization interval 702 (e.g., 2×, 3×, 4×, 5×, etc.).

In one embodiment, for example, each virtual clock V from the set of virtual clocks 634 corresponds to a synchronization loop L that includes a synchronization interval/to control when each virtual clock Vis synchronized with the network time for the TSN 102. Each synchronization interval/is a different multiple of the reference synchronization interval 702.

In one embodiment, for example, the virtual clock manager 632 performs operations such as generating a timestamp 806 for the reference message 706 when received by the TSN node, generating a reference offset value 808 based on the timestamp 806, where the reference offset value 808 corresponds to a synchronization loop L, such as first synchronization loop 1 722 for the first virtual clock 1 712, for example. The virtual clock manager 632 performs operations comprising selecting a virtual clock V corresponding to the synchronization loop L, such as the first virtual clock 1 712 based on the first synchronization loop 1 722, for example.

Similar operations are performed for updating the virtual clock 2 714, virtual clock 3 716, and virtual clock V 718 of the set of virtual clocks 634 on a continuous basis using time information 420 from different reference messages 610 according to the synchronization loop 1 722, synchronization loop 2 724, and synchronization loop 3 726, respectively, using the synchronization interval 2 732, synchronization interval 3 734, and synchronization interval I 736, respectively.

Sometime during the continuous time synchronization process performed by the clock follower node 604, an IDS 110 for the clock follower node 604 may detect an attack on the clock follower node 604 and/or other TSN nodes in the TSN 102. The IDS 110 may generate an alert and send the alert to the clock follower node 604.

The clock follower node 604 receives and decodes the security alert from the IDS 110. The security alert may include a start time for an attack on the TSN 102. The virtual clock manager 632 extracts the start time for the attack, and it identifies a synchronization loop for a virtual clock that occurs after the start time of the attack on the TSN 102, such as a second synchronization loop 2 724 for a second virtual clock 2 714, for example. The virtual clock manager 632 then selects a virtual clock that corresponds to the synchronization loop, such as the second virtual clock 2 714 based on the second synchronization loop 2 724, for example. The virtual clock manager 632 accesses time values generated by the second virtual clock 2 714 as the network time for the TSN 102 by the clock follower node 604. The virtual clock manager 632 may then isolates the set of virtual clocks 634, such as the second virtual clock 2 714, from further adjustments based on time information 420 from future reference messages 610 received and decoded after the security alert.

Although the examples above use the virtual clock 1 712 and the virtual clock 2 714 by way of illustration, it may be appreciated that any of the virtual clocks 634 may be substituted for the virtual clock 1 712 and the virtual clock 2 714 depending on a given synchronization loop used for updating the virtual clocks 634 and when the security alert is received by the clock follower node 604. Embodiments are not limited to these examples.

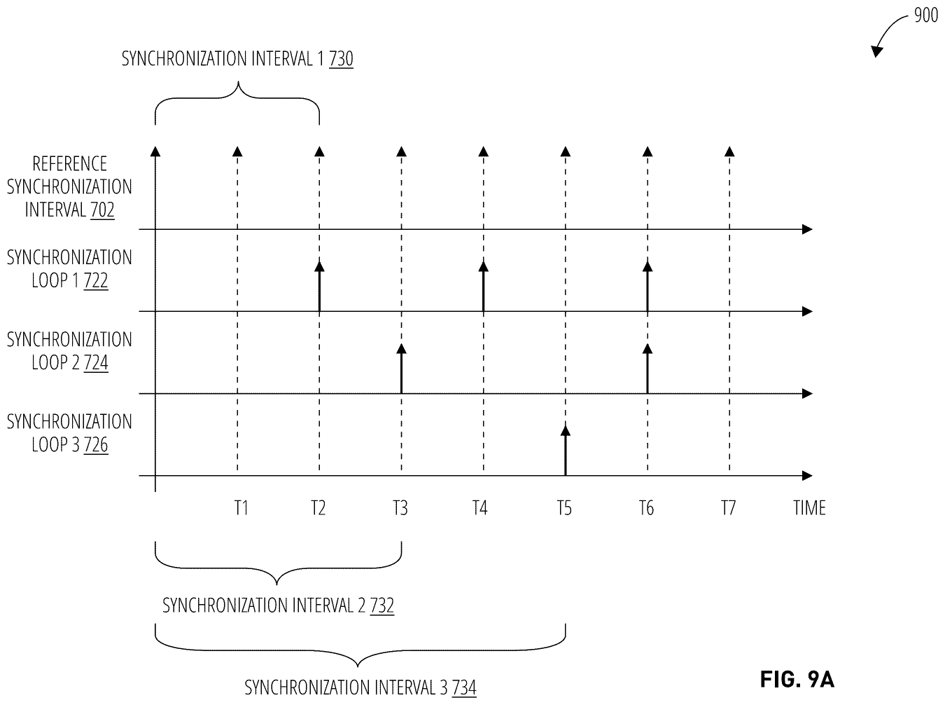

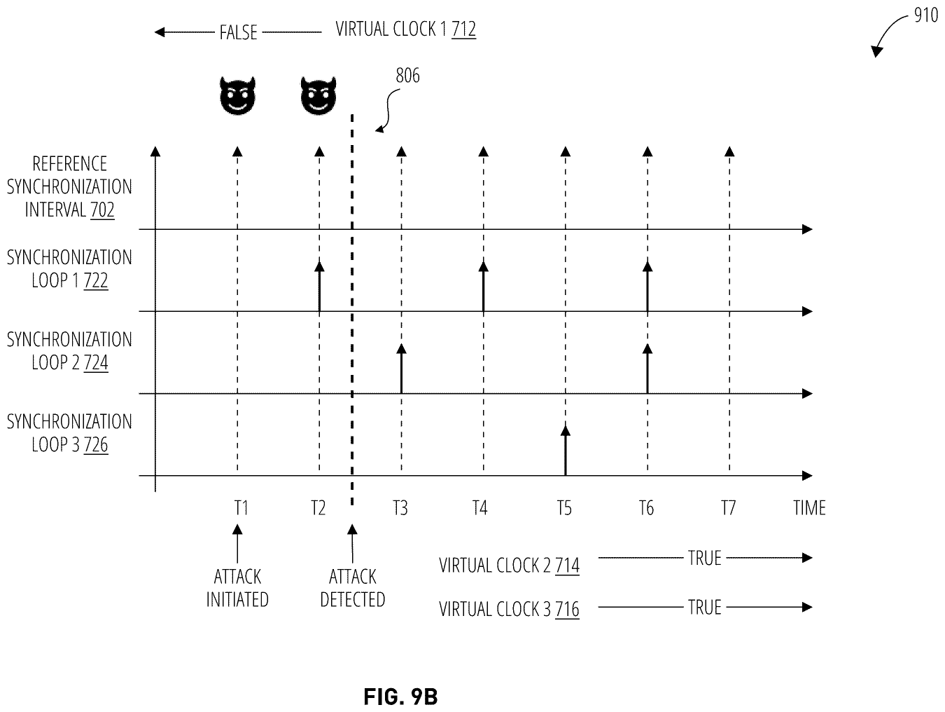

FIG. 9A illustrates a logic diagram 900. The logic diagram 900 is an example of operations of the virtual clock manager 632 of the clock follower node 604. Specifically, the logic diagram 900 is an example of continuous synchronization operations for the virtual clocks 634.

As depicted in logic diagram 900, the reference synchronization interval 702 is a repeating interval TSYNC used by the clock leader node 602 to transmit a first set of reference messages 610. In the example shown in logic diagram 900, the synchronization loop 1 722 of the virtual clock 1 712 uses a synchronization interval 1 730 that is twice as long as the reference synchronization interval 702. In this example, the virtual clock manager 632 updates the virtual clock 1 712 using time information 420 carried by every other reference message of the reference messages 610. The synchronization loop 2 724 of the virtual clock 2 714 uses a synchronization interval 2 732 that is three times as long as the reference synchronization interval 702. Therefore, the virtual clock manager 632 updates the virtual clock 2 714 using time information 420 carried by every third reference message of the reference messages 610. The synchronization loop 3 726 of the virtual clock 3 716 uses a synchronization interval 3 734 that is five times as long as the reference synchronization interval 702. Therefore, the virtual clock manager 632 updates the virtual clock 2 714 using time information 420 carried by every fifth reference message of the reference messages 610. This process continues until the synchronization loop L 728 of the virtual clock V 718 uses a synchronization interval I 736, at which time the process repeats for a second set of reference messages 610, a third set of reference messages 610, and so forth.

The virtual clock manager 632 may select a synchronization loop to update in a number of different ways. In one embodiment, for example, the virtual clock manager 632 may use a count value for an interval counter, where each count value corresponds to a given synchronization loop L, to select which of the synchronization loops 720 to update for a given reference message 706 of the reference messages 610. In other examples, the virtual clock manager 632 may use a MOD operation, a reference offset compute operation, a data structure such as a lookup table, or some other mechanism to select which of the synchronization loops 720 to update for a given reference message 706. Embodiments are not limited in this context.

Although FIG. 9A illustrates a set of virtual clocks 634 with synchronization loops 720 having offsets from, or multiples of, the reference messages 610, it may be appreciated that the virtual clock manager 632 may instantiate a virtual clock of the virtual clocks 634 with a synchronization loop that updates the virtual clock for every reference message 706 of the reference messages 610. In this case, the virtual clock would mirror the hardware clock 636 of the clock follower node 604.

FIG. 9B illustrates a logic diagram 910. The logic diagram 910 is an example of operations of the virtual clock manager 632 of the clock follower node 604. Specifically, the logic diagram 910 is an example of clock recovery operations using the virtual clocks 634 after an IDS 110 detects an attack on the clock leader node 602, clock follower node 604, or other TSN node of the TSN 102.

As depicted in logic diagram 910, assume an IDS 110 detects an attack on the clock follower node 604 of the TSN 102, generates an alert that includes an estimated start time for the attack, and sends the alert to the clock follower node 604. The virtual clock manager 632 receives and decodes the alert, and it extracts the estimated start time for the attack. Alternatively, the alert does not include an estimated start time for the attack. In this case, the virtual clock manager 632 uses a timestamp 806 representing a time when the clock follower node 604 receives the alert as a proxy for the start time for the attack. In either case, the virtual clock manager 632 calculates where the start time of the attack and/or timestamp 806 falls within the synchronization loops 720.

As indicated in logic diagram 910, assume the virtual clock manager 632 implicitly or explicitly determines that a start time of the attack is at time T1 and the alert is received between the second and third reference synchronization interval 702 as represented by T2 and T3, respectively. Based on this information, the virtual clock manager 632 determines that the virtual clock 1 712 has consumed samples with compromised time information 420. Therefore, the virtual clock 1 712 is compromised (e.g., assigned a Boolean value of FALSE) and it cannot be trusted to maintain a clean network time for the TSN 102. However, the virtual clock 2 714 is scheduled to receive a next time update during synchronization loop 2 724 which uses a synchronization interval 2 732 that begins after the timestamp 806. Therefore, the virtual clock 2 714 is not compromised (e.g., assigned a Boolean value of TRUE) and it can be trusted to maintain a clean network time for the TSN 102.

In addition to the virtual clock 2 714 having a clean clock state, it may be appreciated that the virtual clock 3 716 also has a clean clock state as well since it uses synchronization loop 3 726 which uses a synchronization interval 3 734 that also begins after the timestamp 806. However, the virtual clock 2 714 is more accurate relative to the virtual clock 3 716 since it is updated every third reference message 706 while the virtual clock 3 716 is updated every fifth reference message 706. Nonetheless, the virtual clock manager 632 may also select virtual clock 3 716 to maintain a network time for the TSN 102 subsequent to the attack since it also has a clean clock state as well.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware clement, a software clement executed by a processor, or any combination thereof. The embodiments are not limited in this context.

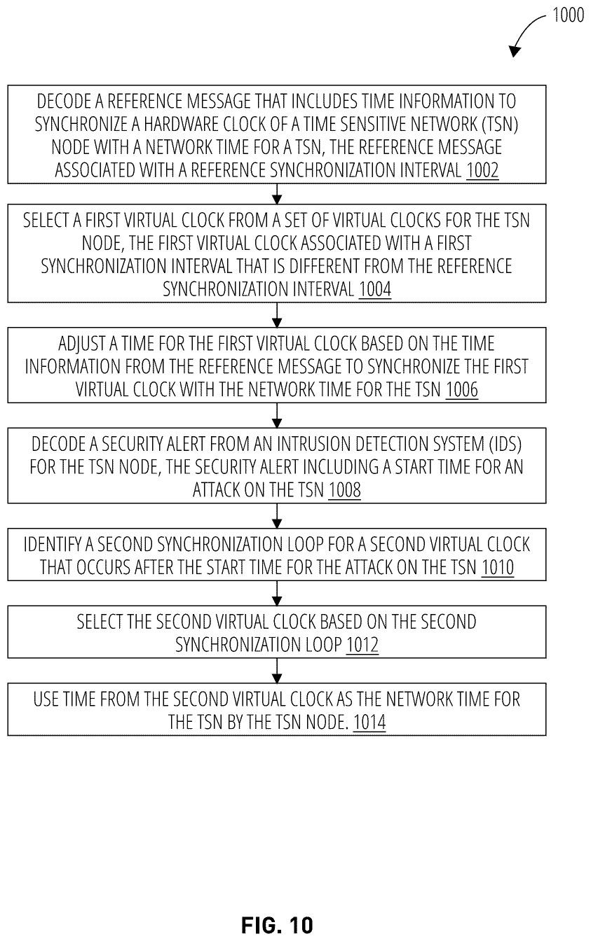

FIG. 10 illustrates an embodiment of a logic flow 1000. The logic flow 1000 may be representative of some or all of the operations executed by one or more embodiments described herein. For example, the logic flow 1000 may include some or all of the operations performed by devices or entities within the TSN 102, TSN 200a, TSN 300a, a TSN node 104, an IDS 110, an apparatus 400, an apparatus 500, a system 600, a clock leader node 602, a clock follower node 604, a virtual clock manager 632, and so forth. More particularly, the logic flow 1000 illustrates an example where a clock follower node 604 receives a set of reference messages 610 transporting time information 420 for one or more TSN nodes 104, and the virtual clock manager 632 updates a set of virtual clocks 634 using a set of synchronization loops 720 using a set of synchronization intervals to perform clock recovery operations for the one or more TSN nodes 104 that are under a security attack.

In block 1002, logic flow 1000 performs decoding a reference message that includes time information to synchronize a hardware clock of a time sensitive network (TSN) node with a network time for a TSN, the reference message associated with a reference synchronization interval. In block 1004, the logic flow 1000 performs selecting a first virtual clock from a set of virtual clocks for the TSN node, the first virtual clock associated with a first synchronization interval that is different from the reference synchronization interval. In block 1006, the logic flow 1000 performs adjusting a time for the first virtual clock based on the time information from the reference message to synchronize the first virtual clock with the network time for the TSN. In block 1008, the logic flow 1000 performs decoding a security alert from an intrusion detection system (IDS) for the TSN node, the security alert including a start time for an attack on the TSN. In block 1010, the logic flow 1000 performs identifying a second synchronization loop for a second virtual clock that occurs after the start time for the attack on the TSN. In block 1012, the logic flow 1000 performs selecting the second virtual clock based on the second synchronization loop. In block 1014, the logic flow 1000 performs using time from the second virtual clock as the network time for the TSN by the TSN node.

By way of example, the virtual clock manager 632 performs decoding a reference message 706 that includes time information 420 to synchronize a hardware clock 636 of a clock follower node 604 with a network time for a TSN 102. The reference message 706 is associated with a reference synchronization interval 702 (e.g., TSYNC). The virtual clock manager 632 performs selecting a first virtual clock 1 712 from a set of virtual clocks 634 for the TSN node 4, the first virtual clock 1 712 associated with a first synchronization interval 1 730 that is different from the reference synchronization interval 702. The virtual clock manager 632 performs adjusting a time for the first virtual clock 1 712 based on the time information 420 from the reference message 706 to synchronize the first virtual clock 1 712 with the network time for the TSN 102. The virtual clock manager 632 performs decoding a security alert from an IDS 110 for the clock follower node 604, the security alert including a start time for an attack on the TSN 102. The virtual clock manager 632 performs identifying a second synchronization loop 2 724 for a second virtual clock 2 714 that occurs after the start time for the attack on the TSN 102. The virtual clock manager 632 performs selecting the second virtual clock 2 714 based on the second synchronization loop 2 724. The virtual clock manager 632 performs using time from the second virtual clock 2 714 as the network time for the TSN 102 by the clock follower node 604. Other embodiments are described and claimed.

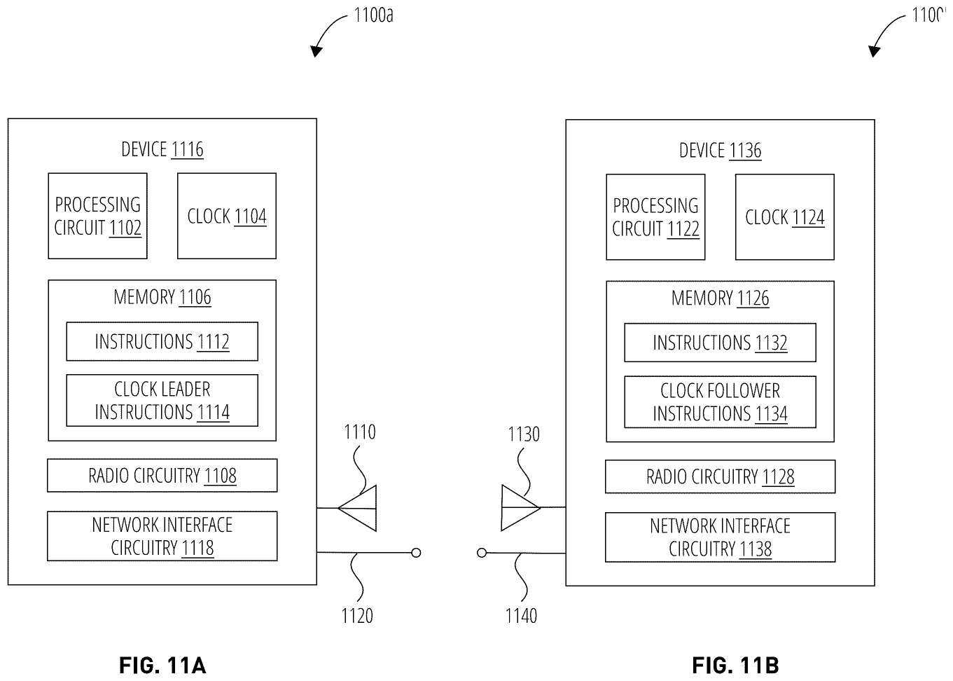

FIG. 11A depicts a device 1116. The device 1116 could be any one of the TSN nodes 104 in a TSN network. Device 1116 includes a processing circuit 1102, a clock 1104, memory 1106, radio circuitry 1108, an antenna 1110, a network interface circuitry 1118, and a wired connection 1120. Memory 1106 stores instructions 1112 and clock leader instructions 1114. During operation, processing circuit 1102 can execute instructions 1112 and/or clock leader instructions 1114 to cause device 1116 to generate a set of reference messages 610 for other devices in the TSN 102, such as a clock follower. In some examples, processing circuit 1102 can execute instructions 1112 and/or clock leader instructions 1114 to cause device 1116 to operate as a clock leader (CL) for the TSN network, such as sending time synchronization messages, time update messages, and other timing messages defined by various IEEE standards as discussed herein. Furthermore, processing circuit 1102 can execute instructions 1112 to cause device 1116 to send, via radio circuitry 1108 and antenna 1110 or network interface circuitry 1118 timing messages as the CL for a CF in a TSN network. In addition, processing circuit 1102 can execute instructions 1112 to cause device 1116 to send, via radio circuitry 1108 and antenna 1110 or network interface circuitry 1118 security messages in response to a security attack, such as alert messages, notification messages, network reconfiguration messages, device isolation messages, model update messages, and other messages in a TSN network.

FIG. 11B depicts a device 1136. The device 1136 could be any one of the TSN nodes 104 in a TSN network. Device 1136 includes a processing circuit 1122, a clock 1124, memory 1126, radio circuitry 1128, an antenna 1130, a network interface circuitry 1138, and a wired connection 1140. Memory 1126 stores instructions 1132 and clock follower instructions 1134. During operation, processing circuit 1122 can execute instructions 1132 and/or clock follower instructions 1134 to cause device 1136 to receive and decode a set of reference messages 610 from other devices in the TSN 102, such as a clock leader. In some examples, processing circuit 1122 can execute instructions 1132 and/or clock follower instructions 1134 to operate as a clock follower (CF) for the TSN network, such as receiving timing messages as a clock follower (e.g., from time measurements from a global clock for a TSN network) from other devices in the TSN network, such as the device 1116. In some examples, processing circuit 1122 can execute instructions 1132 and/or clock follower instructions 1134 to cause device 1136 to receive time synchronization messages, time update messages, and other timing messages defined by various IEEE standards as discussed herein. Furthermore, processing circuit 1122 can execute instructions 1132 and/or clock follower instructions 1134 to cause device 1136 to receive, via radio circuitry 1128 and antenna 1130 or network interface circuitry 1138 timing messages as the CF for a CL in a TSN network. In addition, processing circuit 1122 can execute instructions 1132 and/or clock follower instructions 1134 to cause device 1136 to send, via radio circuitry 1128 and antenna 1130 or network interface circuitry 1138 security messages in response to a security attack, such as alert messages, notification messages, network reconfiguration messages, device isolation messages, model update messages, and other messages in a TSN network.

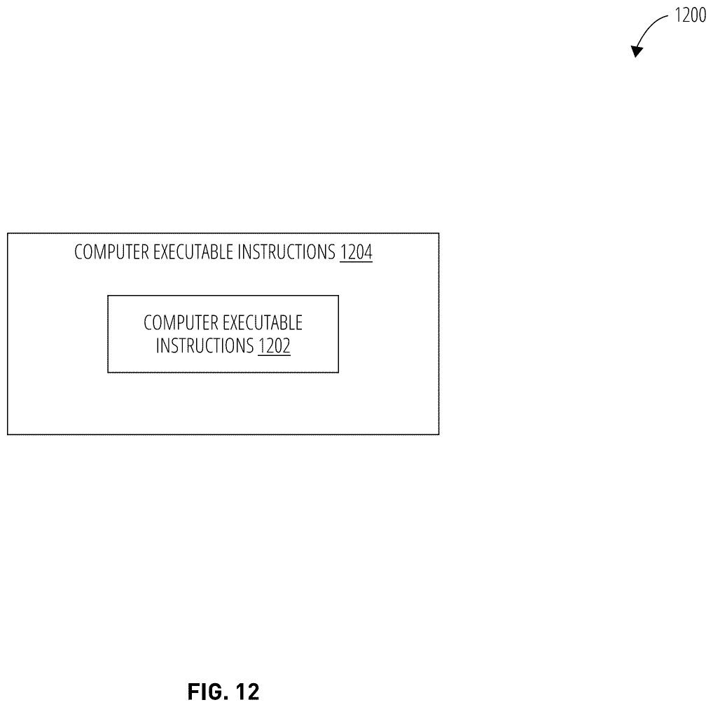

FIG. 12 illustrates computer-readable storage computer-readable medium 1200. Computer-readable storage computer-readable medium 1200 may comprise any non-transitory computer-readable storage medium or machine-readable storage medium, such as an optical, magnetic or semiconductor storage medium. In various embodiments, computer-readable storage computer-readable medium 1200 may comprise an article of manufacture. In some embodiments, computer-readable storage computer-readable medium 1200 may store computer executable instructions 1202 with which circuitry (e.g., processing circuitry 416, processor circuitry 612, processor circuitry 626, processing circuit 1102, processing circuit 1122, radio circuitry 1108, radio circuitry 1128, network interface circuitry 1118, network interface circuitry 1138, clock manager 106, clock circuitry 414, interface 624, interface 638, or the like) can execute. For example, computer executable instructions 1202 can include instructions to implement operations described with respect to logic flows 1900 and 2000. Examples of computer-readable storage computer-readable medium 1200 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1202 may include any suitable type of code, such as source code, compiled code, interpreted code, executable code, static code, dynamic code, object-oriented code, visual code, and the like.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following aspects and examples pertain to further embodiments, from which numerous permutations and configurations will be apparent.

An example method, comprising: decoding a reference message comprising time information to synchronize a hardware clock of a time sensitive network (TSN) node with a network time for a TSN, the reference message associated with a reference synchronization interval; selecting a first virtual clock from a set of virtual clocks for the TSN node, the first virtual clock associated with a first synchronization interval that is different from the reference synchronization interval; and adjusting a time for the first virtual clock based on the time information from the reference message to synchronize the first virtual clock with the network time for the TSN.

Further to any preceding example, wherein the synchronization interval is a multiple of the reference synchronization interval.

Further to any preceding example, wherein each virtual clock from the set of virtual clocks corresponds to a synchronization loop comprising a synchronization interval to control when each virtual clock is synchronized with the network time for the TSN, and each synchronization interval is a different multiple of the reference synchronization interval.

Further to any preceding example, comprising: generating a timestamp for the reference message when received by the TSN node; generating a reference offset value based on the timestamp, the reference offset value corresponding to a first synchronization loop for the first virtual clock; and selecting the first virtual clock based on the first synchronization loop.

Further to any preceding example, comprising: decoding a security alert from an intrusion detection system (IDS) for the TSN node, the security alert including a start time for an attack on the TSN; identifying a second synchronization loop for a second virtual clock that occurs after the start time for the attack on the TSN; selecting the second virtual clock based on the second synchronization loop; and using time from the second virtual clock as the network time for the TSN by the TSN node.

Further to any preceding example, comprising isolating the second virtual clock from further adjustments based on time information from reference messages decoded after the security alert.

Further to any preceding example, wherein the TSN node is a clock follower node for the TSN and the reference message is from a clock leader node for the TSN.

An example computing apparatus comprising: circuitry; and a memory storing instructions that, when executed by the circuitry, causes the circuitry to: decode a reference message comprising time information to synchronize a hardware clock of a time sensitive network (TSN) node with a network time for a TSN, the reference message associated with a reference synchronization interval; select a first virtual clock from a set of virtual clocks for the TSN node, the first virtual clock associated with a first synchronization interval that is different from the reference synchronization interval; and adjust a time for the first virtual clock based on the time information from the reference message to synchronize the first virtual clock with the network time for the TSN.

Further to any preceding example, wherein the synchronization interval is a multiple of the reference synchronization interval. Further to any preceding example, wherein each virtual clock from the set of virtual clocks corresponds to a synchronization loop comprising a synchronization interval to control when each virtual clock is synchronized with the network time for the TSN, and each synchronization interval is a different multiple of the reference synchronization interval.

Further to any preceding example, the circuitry to: generate a timestamp for the reference message when received by the TSN node; generate a reference offset value based on the timestamp, the reference offset value corresponding to a first synchronization loop for the first virtual clock; and select the first virtual clock based on the first synchronization loop.

Further to any preceding example, the circuitry to: decode a security alert from an intrusion detection system (IDS) for the TSN node, the security alert including a start time for an attack on the TSN; identify a second synchronization loop for a second virtual clock that occurs after the start time for the attack on the TSN; select the second virtual clock based on the second synchronization loop; and using time from the second virtual clock as the network time for the TSN by the TSN node.

Further to any preceding example, the circuitry to isolate the second virtual clock from further adjustments based on time information from reference messages decoded after the security alert. Further to any preceding example, wherein the TSN node is a clock follower node for the TSN and the reference message is from a clock leader node for the TSN.

An example non-transitory computer-readable storage medium, the computer-readable storage medium including instructions that when executed by circuitry, causes the circuitry to: decode a reference message comprising time information to synchronize a hardware clock of a time sensitive network (TSN) node with a network time for a TSN, the reference message associated with a reference synchronization interval; select a first virtual clock from a set of virtual clocks for the TSN node, the first virtual clock associated with a first synchronization interval that is different from the reference synchronization interval; and adjust a time for the first virtual clock based on the time information from the reference message to synchronize the first virtual clock with the network time for the TSN.

Further to any preceding example, wherein the synchronization interval is a multiple of the reference synchronization interval.

Further to any preceding example, wherein each virtual clock from the set of virtual clocks corresponds to a synchronization loop comprising a synchronization interval to control when each virtual clock is synchronized with the network time for the TSN, and each synchronization interval is a different multiple of the reference synchronization interval.

Further to any preceding example, comprising instructions that when executed by circuitry, causes the circuitry to: generate a timestamp for the reference message when received by the TSN node; generate a reference offset value based on the timestamp, the reference offset value corresponding to a first synchronization loop for the first virtual clock; and select the first virtual clock based on the first synchronization loop.

Further to any preceding example, comprising instructions that when executed by circuitry, causes the circuitry to: decode a security alert from an intrusion detection system (IDS) for the TSN node, the security alert including a start time for an attack on the TSN; identify a second synchronization loop for a second virtual clock that occurs after the start time for the attack on the TSN; select the second virtual clock based on the second synchronization loop; and using time from the second virtual clock as the network time for the TSN by the TSN node.

Further to any preceding example, comprising instructions that when executed by circuitry, causes the circuitry to isolate the second virtual clock from further adjustments based on time information from reference messages decoded after the security alert.

It may be appreciated that any of the previous examples may be implemented as systems and/or means plus function embodiments. Embodiments are not limited to these examples.

What is claimed is:

1. A method, comprising:
decoding a reference message comprising time information to synchronize a hardware clock of a time sensitive network (TSN) node with a network time for a TSN, the reference message associated with a reference synchronization interval;
selecting a first virtual clock from a set of virtual clocks for the TSN node, the first virtual clock associated with a first synchronization interval that is different from the reference synchronization interval; and
adjusting a time for the first virtual clock based on the time information from the reference message to synchronize the first virtual clock with the network time for the TSN.

2. The method of claim 1, wherein the synchronization interval is a multiple of the reference synchronization interval.

3. The method of claim 1, wherein each virtual clock from the set of virtual clocks corresponds to a synchronization loop comprising a synchronization interval to control when each virtual clock is synchronized with the network time for the TSN, and each synchronization interval is a different multiple of the reference synchronization interval.

4. The method of claim 1, comprising:
generating a timestamp for the reference message when received by the TSN node;
generating a reference offset value based on the timestamp, the reference offset value corresponding to a first synchronization loop for the first virtual clock; and
selecting the first virtual clock based on the first synchronization loop.

5. The method of claim 1, comprising:
decoding a security alert from an intrusion detection system (IDS) for the TSN node, the security alert including a start time for an attack on the TSN;
identifying a second synchronization loop for a second virtual clock that occurs after the start time for the attack on the TSN;
selecting the second virtual clock based on the second synchronization loop; and
using time from the second virtual clock as the network time for the TSN by the TSN node.

6. The method of claim 5, comprising isolating the second virtual clock from further adjustments based on time information from reference messages decoded after the security alert.

7. The method of claim 1, wherein the TSN node is a clock follower node for the TSN and the reference message is from a clock leader node for the TSN.

8. A computing apparatus comprising:
circuitry; and
a memory storing instructions that, when executed by the circuitry, causes the circuitry to:
decode a reference message comprising time information to synchronize a hardware clock of a time sensitive network (TSN) node with a network time for a TSN, the reference message associated with a reference synchronization interval;
select a first virtual clock from a set of virtual clocks for the TSN node, the first virtual clock associated with a first synchronization interval that is different from the reference synchronization interval; and
adjust a time for the first virtual clock based on the time information from the reference message to synchronize the first virtual clock with the network time for the TSN.

9. The computing apparatus of claim 8, wherein the synchronization interval is a multiple of the reference synchronization interval.

10. The computing apparatus of claim 8, wherein each virtual clock from the set of virtual clocks corresponds to a synchronization loop comprising a synchronization interval to control when each virtual clock is synchronized with the network time for the TSN, and each synchronization interval is a different multiple of the reference synchronization interval.

11. The computing apparatus of claim 8, the circuitry to:
generate a timestamp for the reference message when received by the TSN node;
generate a reference offset value based on the timestamp, the reference offset value corresponding to a first synchronization loop for the first virtual clock; and
select the first virtual clock based on the first synchronization loop.

12. The computing apparatus of claim 8, the circuitry to:
decode a security alert from an intrusion detection system (IDS) for the TSN node, the security alert including a start time for an attack on the TSN;
identify a second synchronization loop for a second virtual clock that occurs after the start time for the attack on the TSN;
select the second virtual clock based on the second synchronization loop; and
using time from the second virtual clock as the network time for the TSN by the TSN node.

13. The computing apparatus of claim 12, the circuitry to isolate the second virtual clock from further adjustments based on time information from reference messages decoded after the security alert.

14. The computing apparatus of claim 8, wherein the TSN node is a clock follower node for the TSN and the reference message is from a clock leader node for the TSN.

15. A non-transitory computer-readable storage medium, the computer-readable storage medium including instructions that when executed by circuitry, causes the circuitry to:
decode a reference message comprising time information to synchronize a hardware clock of a time sensitive network (TSN) node with a network time for a TSN, the reference message associated with a reference synchronization interval;
select a first virtual clock from a set of virtual clocks for the TSN node, the first virtual clock associated with a first synchronization interval that is different from the reference synchronization interval; and
adjust a time for the first virtual clock based on the time information from the reference message to synchronize the first virtual clock with the network time for the TSN.

16. The computer-readable storage medium of claim 15, wherein the synchronization interval is a multiple of the reference synchronization interval.

17. The computer-readable storage medium of claim 15, wherein each virtual clock from the set of virtual clocks corresponds to a synchronization loop comprising a synchronization interval to control when each virtual clock is synchronized with the network time for the TSN, and each synchronization interval is a different multiple of the reference synchronization interval.

18. The computer-readable storage medium of claim 15, comprising instructions that when executed by circuitry, causes the circuitry to:
generate a timestamp for the reference message when received by the TSN node;
generate a reference offset value based on the timestamp, the reference offset value corresponding to a first synchronization loop for the first virtual clock; and
select the first virtual clock based on the first synchronization loop.

19. The computer-readable storage medium of claim 15, comprising instructions that when executed by circuitry, causes the circuitry to:
decode a security alert from an intrusion detection system (IDS) for the TSN node, the security alert including a start time for an attack on the TSN;
identify a second synchronization loop for a second virtual clock that occurs after the start time for the attack on the TSN;
select the second virtual clock based on the second synchronization loop; and
using time from the second virtual clock as the network time for the TSN by the TSN node.

20. The computer-readable storage medium of claim 19, comprising instructions that when executed by circuitry, causes the circuitry to isolate the second virtual clock from further adjustments based on time information from reference messages decoded after the security alert.
